(19) United States
(12) Patent Application Publication
(10) Pub. No.: US 2025/0155681 A1
(43) Pub. Date: May 15, 2025

(54) OPTICAL IMAGING SYSTEM

(71) Applicant: SAMSUNG ELECTRO-MECHANICS CO., LTD., Suwon-si (KR)

(72) Inventor: Sang Hyun JANG, Suwon-si (KR)

(73) Assignee: SAMSUNG ELECTRO-MECHANICS CO., LTD., Suwon-si (KR)

(21) Appl. No.: 18/607,975

(22) Filed: Mar. 18, 2024

(30) Foreign Application Priority Data
Nov. 10, 2023 (KR) 10-2023-0155782

(51) Int. Cl. G02B 13/00; G02B 9/64

(52) U.S. Cl. CPC G02B 13/0045; G02B 9/64

(57) ABSTRACT

An optical imaging system includes a first lens, a second lens, a third lens, a fourth lens having a positive refractive power, a fifth lens, a sixth lens, a seventh lens, and an eighth lens having a convex object-side surface, sequentially arranged from an object side to an imaging plane side. The optical imaging system satisfies: TTL/(2*IMG HT)*Fno<1.000, where TTL is a distance from an object-side surface of the first lens to an imaging plane, IMG HT is half a diagonal length of the imaging plane, and Fno is an F value of the optical imaging system.

### CROSS-REFERENCE TO RELATED APPLICATION(S)

This application claims the benefit under 35 USC 119 (a) of Korean Patent Application No. 10-2023-0155782 filed on Nov. 10, 2023, in the Korean Intellectual Property Office, the entire disclosure of which is incorporated herein by reference for all purposes.

### BACKGROUND

### 1. Field

The present disclosure relates to an optical imaging system employed in mobile devices.

### 2. Description of the Background

High-performance cameras are used in mobile devices and may include relatively large image sensors with a large number of pixels.

Meanwhile, it is common for the size of a lens to increase proportionately to the size of an image sensor. However, since mobile devices are restricted in thickness, it is difficult to manufacture a lens to match the size of an image sensor. Moreover, even if an increase in lens size is minimized, it is difficult to avoid designs that may deteriorate aesthetics, such as a camera bump, due to the slimming of mobile devices.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens having a positive refractive power, a fifth lens, a sixth lens, a seventh lens, and an eighth lens having a convex object-side surface, sequentially arranged from an object side to an imaging plane side. The optical imaging system satisfies: TTL/(2*IMG HT)*Fno<1.000, where TTL is a distance from an object-side surface of the first lens to an imaging plane, IMG HT is half a diagonal length of the imaging plane, and Fno is an F value of the optical imaging system.

The optical imaging system may further include a stop disposed between the third lens and the fourth lens.

The second lens and the fifth lens may have an Abbe number of less than 20.

The fourth lens may have a convex object-side surface.

The fourth lens may have a convex image-side surface.

The sixth lens may have a negative refractive power.

The optical imaging system satisfies: 1.100≤TTL/f≤1.200, where f is a focal length of the optical imaging system.

The third lens may have a positive refractive power, and the fifth lens may have a negative refractive power.

In another general aspect, an optical imaging system includes a first lens having a positive refractive power; a second lens having a negative refractive power; a third lens having a positive refractive power; a fourth lens having a refractive power; a fifth lens having a negative refractive power; a sixth lens having a refractive power; a seventh lens having a positive refractive power; and an eighth lens having a negative refractive power, wherein the first to eighth lenses are sequentially arranged from an object side to an imaging plane side, and wherein the optical imaging system satisfies: TTL/(2*IMG HT)*Fno<1.000, where TTL is a distance from an object-side surface of the first lens to an imaging plane, IMG HT is half a diagonal length of the imaging plane, and Fno is an F value of the optical imaging system.

The optical imaging system may further include a stop disposed between the third lens and the fourth lens, wherein the optical imaging system satisfies: v2+v5<40, where v2 has an Abbe number of the second lens, and v5 has an Abbe number of the fifth lens.

The fourth lens may have a positive refractive power and a convex image-side surface.

The eighth lens may have a convex object-side surface.

The fourth lens may have a convex object-side surface.

The sixth lens may have a positive refractive power.

The sixth lens may have a convex object-side surface and a concave image-side surface.

The optical imaging system may satisfy: 0.500≤TTL/(2*IMG HT)<0.620.

Other features and aspects will be apparent from the following detailed description, the drawings, and the claims.

### BRIEF DESCRIPTION OF DRAWINGS

FIG. 1A is a configuration diagram of an optical imaging system according to a first embodiment of the present disclosure.

FIG. 1B are graphs illustrating the aberration characteristics of the optical imaging system according to the first embodiment of the present disclosure.

FIG. 2A is a configuration diagram of an optical imaging system according to a second embodiment of the present disclosure.

FIG. 2B are graphs illustrating the aberration characteristics of the optical imaging system according to the second embodiment of the present disclosure.

FIG. 3A is a configuration diagram of an optical imaging system according to a third embodiment of the present disclosure.

FIG. 3B are graphs illustrating the aberration characteristics of the optical imaging system according to the third embodiment of the present disclosure.

FIG. 4A is a configuration diagram of an optical imaging system according to a fourth embodiment of the present disclosure.

FIG. 4B are graphs illustrating the aberration characteristics of the optical imaging system according to the fourth embodiment of the present disclosure.

FIG. 5A is a configuration diagram of an optical imaging system according to a fifth embodiment of the present disclosure.

FIG. 5B are graphs illustrating the aberration characteristics of the optical imaging system according to the fifth embodiment of the present disclosure.

FIG. 6A is a configuration diagram of an optical imaging system according to a sixth embodiment of the present disclosure.

FIG. 6B are graphs illustrating the aberration characteristics of the optical imaging system according to the sixth embodiment of the present disclosure.

FIG. 7A is a configuration diagram of an optical imaging system according to a seventh embodiment of the present disclosure.

FIG. 7B are graphs illustrating the aberration characteristics of the optical imaging system according to the seventh embodiment of the present disclosure.

FIG. 8A is a configuration diagram of an optical imaging system according to an eighth embodiment of the present disclosure.

FIG. 8B are graphs illustrating the aberration characteristics of the optical imaging system according to the eighth embodiment of the present disclosure.

FIG. 9A is a configuration diagram of an optical imaging system according to a ninth embodiment of the present disclosure.

FIG. 9B are graphs illustrating the aberration characteristics of the optical imaging system according to the ninth embodiment of the present disclosure.

FIG. 10A is a configuration diagram of an optical imaging system according to a tenth embodiment of the present disclosure.

FIG. 10B are graphs illustrating the aberration characteristics of the optical imaging system according to the tenth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In this specification, numerical values for units of a radius of curvature of a lens, a thickness, a gap or a distance, a focal length, IMG HT (½ of a diagonal length of an imaging plane), an effective radius (semi-aperture), and the like are indicated in millimeters (mm), and a unit of field of view (FOV) is degree. In addition, a thickness of a lens and a gap between lenses may refer to a thickness and gap on an optical axis, respectively.

In this specification, an object side may indicate a direction in which an object is located, and an image side may indicate, for example, a direction in which an imaging plane on which an image is formed is located, or a direction in which an image sensor is located.

In descriptions related to a shape of a lens in this specification, a convex shape on one surface means that a paraxial region (a very narrow region near an optical axis) portion of the a surface is convex, and a concave shape on one surface means that a paraxial region portion of the a surface is concave. Therefore, even in the case that one surface of a lens is described as having a convex shape, an edge portion of the lens may be concave. Likewise, even in the case that one surface of a lens is described as having a concave shape, an edge portion of the lens may be convex.

According to embodiments of the present disclosure, an optical imaging system may be employed in a mobile device's camera. The mobile device may be any type of portable electronic device, such as a mobile communication terminal, a smartphone, a tablet PC, or the like.

An optical imaging system may include eight lenses in embodiments of the present disclosure. For example, the optical imaging system may include a first lens, a second lens, a third lens, a fourth lens, a fifth lens, a sixth lens, a seventh lens, and an eighth lens, arranged in order from an object side.

In addition, the optical imaging system may not consist of only a plurality of lenses, but may further include an image sensor converting incident light into an electrical signal, an infrared cut-off filter blocking light in an infrared region incident on the image sensor, and a stop adjusting an amount of incident light.

In embodiments of the present disclosure, the optical imaging system may include a lens formed of a plastic material. For example, at least some of the first to eighth lenses may be formed of a plastic material. In an example, all of the first to eighth lenses may be formed of a plastic material.

In embodiments of the present disclosure, the optical imaging system may include an aspherical lens. For example, at least one of the first to eighth lenses may be an aspherical lens, and at least one of the first to eighth lenses may have an aspherical surface, at least one of an object-side surface, or an image-side surface. The aspherical surface of a lens may be expressed by Equation 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} \qquad Equation 1$$

In Equation 1, c is the reciprocal of a radius of curvature of a lens, K is a conic constant, and Y is a distance from any point on the aspherical surface to an optical axis. In addition, constants A to J are aspherical surface constants from the 4th to the 20th order in sequence, and Z (or SAG) is a distance in an optical axis direction from a certain point on the aspherical surface to a vertex of the corresponding aspherical surface.

In embodiments of the present disclosure, the optical imaging system may satisfy the following conditional expressions:

$$1.1 \leq TTL / f \leq 1.2 \qquad Conditional Expression 1$$

$$0.5 \leq TTL / ( {2}^{*} IMG HT ) < 0.62 \qquad Conditional Expression 2$$

$${\{ TTL / ( {2}^{*} IMG HT ) \}}^{*} Fno < 1. \qquad Conditional Expression 3$$

$$v 2 + v 5 < 40 \qquad Conditional Expression 4$$

$$10 < T 56 / T 12 \qquad Conditional Expression 5$$

$$1.4 < R 6 / f \qquad Conditional Expression 6$$

In Conditional Expression 1, TTL is a distance on an optical axis from an object-side surface of the first lens to an imaging plane, and f is a focal length of the optical imaging system. Conditional Expression 1 may be related to a characteristic that a size of an optical imaging system, according to embodiments of the present disclosure, is small.

In Conditional Expression 2, TTL is a distance on an optical axis from an object-side surface of the first lens to an imaging plane, and IMG HT is half a diagonal length of the imaging plane (2*IMG HT is the diagonal length of the imaging plane). Conditional Expression 2 may be related to a characteristic that a size of an optical imaging system, according to embodiments of the present disclosure, is small compared to an image sensor size.

Conditional Expression 3 may be related to size and brightness characteristics of an optical imaging system according to embodiments of the present disclosure.

In Conditional Expression 4, v2 and v5 are Abbe numbers of the second lens and the fifth lens, respectively. Conditional Expression 4 may be related to design conditions for improving chromatic aberration correction performance of an optical imaging system according to embodiments of the present disclosure.

In Conditional Expression 5, T12 is a gap between the first lens and the second lens, and T56 is a gap between the fifth lens and the sixth lens. Conditional Expression 5 may be related to design conditions for manufacturing an optical imaging system according to embodiments of the present disclosure having a small size, as compared to a size of an image sensor. The gap between the first lens and the second lens may decrease to reduce an overall length while maintaining chromatic aberration correction performance.

In Conditional Equation 6, R6 is a radius of curvature of an image-side surface of the third lens, and f is a focal length of an optical imaging system. Conditional Expression 6 may be related to a shape condition of the third lens that may reduce a size of an optical imaging system according to embodiments of the present disclosure.

Hereinafter, an optical imaging system, according to embodiments of the present disclosure, will be described with reference to the attached drawings.

### First Embodiment

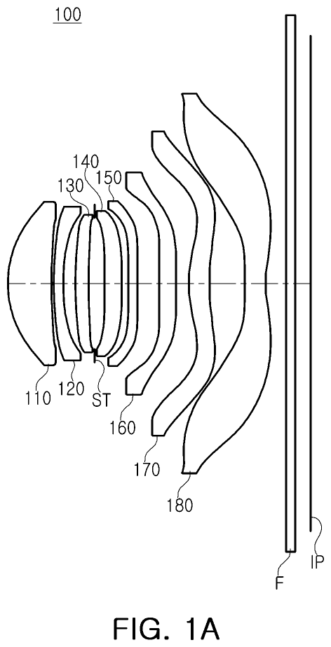

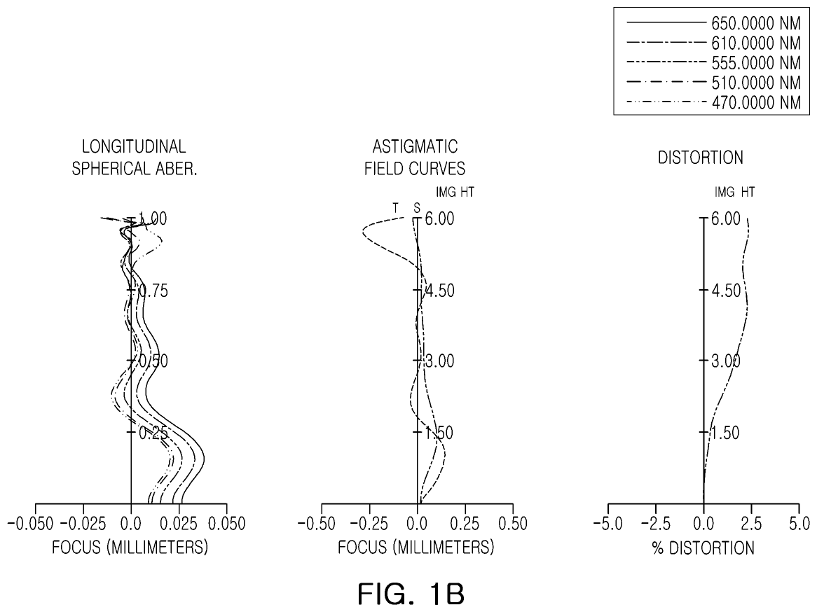

FIG. 1A is a configuration diagram of an optical imaging system according to a first embodiment of the present disclosure. FIG. 1B are graphs illustrating the aberration characteristics of the optical imaging system according to the first embodiment of the present disclosure.

According to the first embodiment, an optical imaging system 100 may include a first lens 110, a second lens 120, a third lens 130, a fourth lens 140, a fifth lens 150, a sixth lens 160, a seventh lens 170, and an eighth lens 180, sequentially arranged from an object side, and may further include an infrared cut-off filter F and an image sensor (an imaging plane (IP)), arranged on an image side of the eighth lens 180. Additionally, the optical imaging system 100 may further include a stop ST disposed between the third lens 130 and the fourth lens 140.

The first lens 110 may have a positive refractive power. An object-side surface of the first lens 110 may be convex in a paraxial region, and an image-side surface of the first lens 110 may be concave in the paraxial region. The first lens 110 may be formed of a plastic material. Additionally, the first lens 110 may be an aspherical lens. For example, the first lens 110 may be a double-sided aspherical lens in which both the object-side surface and the image-side surface are aspherical.

The second lens 120 may have a negative refractive power. An object-side surface of the second lens 120 may be convex in a paraxial region, and an image-side surface of the second lens 120 may be concave in the paraxial region. The second lens 120 may be formed of a plastic material. For example, the second lens 120 may be formed of a plastic material having different optical properties (e.g., a different refractive index and Abbe number) than the first lens 110. In an example, an Abbe number of the second lens 120 may be less than 20. Additionally, the second lens 120 may be an aspherical lens. For example, the second lens 120 may be a double-sided aspherical lens in which both the object-side surface and the image-side surface are aspherical.

The third lens 130 may have a positive refractive power. An object-side surface of the third lens 130 may be convex in a paraxial region, and an image-side surface of the third lens 130 may be concave in the paraxial region. The third lens 130 may be formed of a plastic material. For example, the third lens 130 may be formed of a plastic material having different optical properties (e.g., a different refractive index and Abbe number) than the second lens 120. Additionally, the third lens 130 may be an aspherical lens. For example, the third lens 130 may be a double-sided aspherical lens in which both the object-side surface and the image-side surface are aspherical.

The fourth lens 140 may have a positive refractive power. An object-side surface of the fourth lens 140 may be concave in a paraxial region, and an image-side surface of the fourth lens 140 may be convex in the paraxial region. The fourth lens 140 may be formed of a plastic material. For example, the fourth lens 140 may be formed of a plastic material having different optical properties (e.g., a different refractive index and Abbe number) than the third lens 130. Additionally, the fourth lens 140 may be an aspherical lens. For example, the fourth lens 140 may be a double-sided aspherical lens in which both the object-side surface and the image-side surface are aspherical.

The fifth lens 150 may have a negative refractive power. An object-side surface of the fifth lens 150 may be convex in a paraxial region, and an image-side surface of the fifth lens 150 may be concave in the paraxial region. The fifth lens 150 may be formed of a plastic material. For example, the fifth lens 150 may be formed of a plastic material with different optical properties (e.g., a different refractive index and Abbe number) than the fourth lens 140, and in an example, an Abbe number of the fifth lens 150 may be less than 20. Additionally, the fifth lens 150 may be an aspherical lens. For example, the fifth lens 150 may be a double-sided aspherical lens in which both the object-side surface and the image-side surface are aspherical.

The sixth lens 160 may have a negative refractive power. An object-side surface of the sixth lens 160 may be convex in a paraxial region, and an image-side surface of the sixth lens 160 may be concave in the paraxial region. The sixth lens 160 may be formed of a plastic material. For example, the sixth lens 160 may be formed of a plastic material having different optical properties (e.g., a different refractive index and Abbe number) than the fifth lens 150. Additionally, the sixth lens 160 may be an aspherical lens. For example, the sixth lens 160 may be a double-sided aspherical lens in which both the object-side surface and the image-side surface are aspherical.

The seventh lens 170 may have a positive refractive power. An object-side surface of the seventh lens 170 may be convex in a paraxial region, and an image-side surface of the seventh lens 170 may be concave in the paraxial region. The seventh lens 170 may be formed of a plastic material. For example, the seventh lens 170 may be formed of a plastic material having different optical properties (e.g., a different refractive index and Abbe number) than the sixth lens 160. Additionally, the seventh lens 170 may be an aspherical lens. For example, the seventh lens 170 may be a double-sided aspherical lens in which both the object-side surface and the image-side surface are aspherical.

The eighth lens 180 may have a negative refractive power. An object-side surface of the eighth lens 180 may be convex in a paraxial region, and an image-side surface of the eighth lens 180 may be concave in the paraxial region. The eighth lens 180 may be formed of a plastic material. For example, the eighth lens 180 may be formed of a plastic material having different optical properties (e.g., a different refractive index and Abbe number) than the seventh lens 170. Additionally, the eighth lens 180 may be an aspherical lens. For example, the eighth lens 180 may be a double-sided aspherical lens in which both the object-side surface and the image-side surface are aspherical.

Table 1 below illustrates optical and physical parameters of the optical imaging system 100 according to the first embodiment of the present disclosure.

TABLE 1

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.487 | 1.070 | 1.546 | 55.990 | 1.981 |
| 2 | 11.889 | 0.050 | | | 1.922 |
| 3 | 10.188 | 0.220 | 1.677 | 19.238 | 1.838 |
| 4 | 4.720 | 0.304 | | | 1.687 |
| 5 | 8.191 | 0.315 | 1.570 | 37.403 | 1.667 |
| 6 | 11.866 | 0.140 | | | 1.585 |
| STOP | Infinity | 0.237 | | | 1.534 |
| 7 | −27.704 | 0.417 | 1.546 | 55.990 | 1.602 |
| 8 | −10.738 | 0.156 | | | 1.749 |
| 9 | 28.760 | 0.220 | 1.677 | 19.238 | 1.790 |
| 10 | 10.926 | 0.535 | | | 2.004 |
| 11 | 36.482 | 0.400 | 1.570 | 37.403 | 2.282 |
| 12 | 24.474 | 0.318 | | | 2.702 |
| 13 | 2.926 | 0.500 | 1.546 | 55.990 | 3.354 |
| 14 | 6.872 | 0.859 | | | 3.641 |
| 15 | 23.402 | 0.500 | 1.537 | 55.735 | 4.729 |
| 16 | 2.396 | 0.500 | | | 4.496 |
| 17 | Infinity | 0.210 | 1.518 | 64.197 | |
| 18 | Infinity | 0.369 | | | |
| Image | Infinity | | | | |

Table 2 below illustrates aspheric data of the optical imaging system 100 according to the first embodiment of the present disclosure.

TABLE 2

| Surface | 1 | 2 | 3 | 4 | 5 | 6 | 8 | 9 |
|---|---|---|---|---|---|---|---|---|
| K | −6.78E−01 | −6.69E+01 | 2.26E+01 | 3.21E+00 | 1.99E+01 | 4.99E+01 | −5.53e+01 | 2.08E+01 |
| A | −6.20E−03 | 9.38E−03 | 1.43E−04 | 4.00E−04 | −1.44E−02 | −2.02E−02 | 2.24E−02 | 2.01E−02 |
| B | 2.74E−02 | −1.19E−02 | 7.46E−03 | 7.40E−03 | −4.99E−04 | 3.31E−02 | −9.29E−02 | −1.19E−02 |
| C | −3.54E−02 | −3.43E−03 | −4.59E−02 | −2.67E−02 | −1.01E−02 | −9.31E−02 | 1.65E−01 | −3.12E−02 |
| D | 2.82E−02 | 1.60E−02 | 7.11E−02 | 3.57E−02 | 1.29E−02 | 1.31E−01 | −2.06E−01 | 5.89E−02 |
| E | −1.41E−02 | −1.38E−02 | −5.50E−02 | −2.19E−02 | −7.11E−03 | −1.12E−01 | 1.62E−01 | −5.47E−02 |
| F | 4.48E−03 | 6.05E−03 | 2.46E−02 | 6.19E−03 | 2.19E−03 | 6.11E−02 | −8.06E−02 | 2.89E−02 |
| G | −8.68E−04 | −1.50E−03 | −6.49E−03 | −3.20E−04 | −3.42E−04 | −2.05E−02 | 2.45E−02 | −8.88E−03 |
| H | 9.32E−05 | 2.00E−04 | 9.37E−04 | −1.84E−04 | 4.98E−05 | 3.88E−03 | −4.14E−03 | 1.49E−03 |
| J | −4.26E−06 | −1.13E−05 | −5.72E−05 | 2.54E−05 | −8.90E−06 | −3.16E−04 | 2.94E−04 | −1.08E−04 |
| Surface | 10 | 11 | 12 | 13 | 14 | 15 | 16 | 17 |
| K | 7.11E+01 | −7.70E+01 | −2.33E+01 | 5.56E+01 | −1.11E+01 | −5.60E+01 | 1.51E+01 | −1.10E+01 |
| A | −1.35E−02 | −3.20E−02 | −9.73E−03 | −4.82E−02 | 1.23E−02 | 2.59E−02 | −1.34E−01 | −6.12E−02 |
| B | −4.36E−02 | 1.10E−03 | −8.01E−03 | 3.24E−03 | −1.77E−02 | −1.49E−02 | 4.91E−02 | 1.89E−02 |
| C | 3.04E−02 | −2.37E−02 | −8.63E−03 | 1.06E−03 | 4.07E−03 | 1.96E−03 | −1.10E−02 | −3.64E−03 |
| D | 6.44E−03 | 4.14E−02 | 1.59E−02 | −4.00E−05 | −5.88E−04 | 2.39E−04 | 1.58E−03 | 4.29E−04 |
| E | −2.54E−02 | −3.37E−02 | −1.15E-02 | −4.14E−04 | 5.23E−05 | −1.36E−04 | −1.47E−04 | −3.04E−05 |
| F | 1.71E−02 | 1.51E−02 | 4.50E−03 | 1.97E−04 | −1.42E−06 | 2.27E−05 | 8.74E−06 | 1.23E−06 |
| G | −5.61E−03 | −3.84E−03 | −9.97E−04 | −3.79E−05 | −1.59E−07 | −1.90E−06 | −3.21E−07 | −2.46E−08 |
| H | 9.41E−04 | 5.21E−04 | 1.17E−04 | 3.38E−06 | 1.39E−08 | 8.02E−08 | 6.66E−09 | 1.07E−10 |
| J | −6.57E−05 | −2.91E−05 | −5.59E−06 | −1.16E−07 | −3.25E−10 | −1.36E−09 | −5.98E−11 | 2.18E−12 |

### Second Embodiment

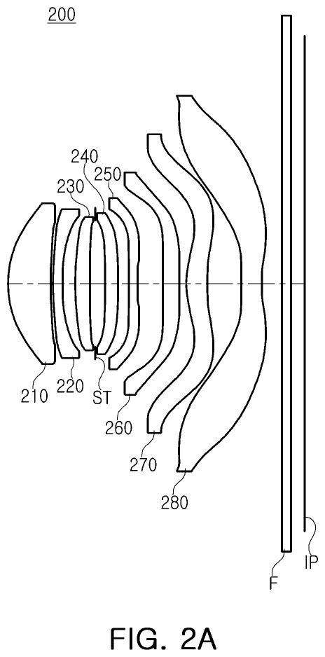

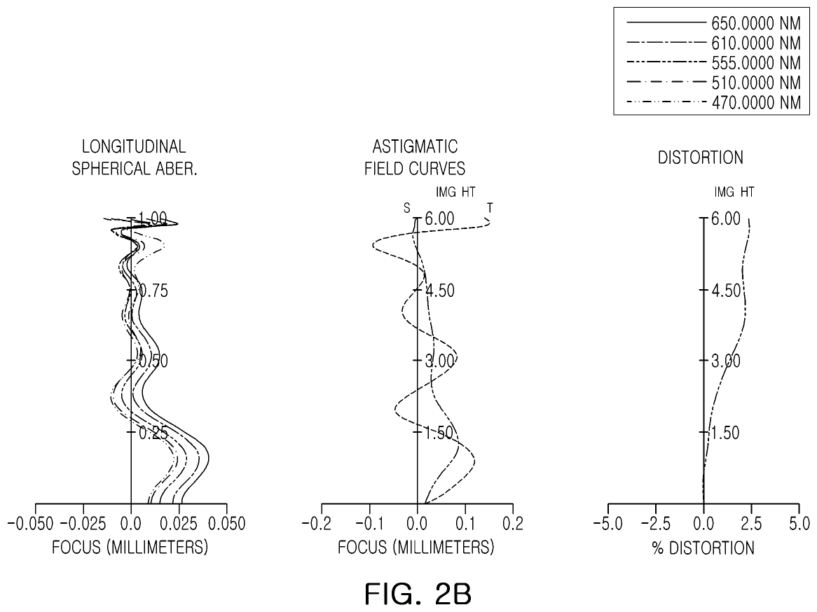

FIG. 2A is a configuration diagram of an optical imaging system according to a second embodiment of the present disclosure. FIG. 2B are graphs illustrating the aberration characteristics of the optical imaging system according to the second embodiment of the present disclosure.

According to the second embodiment, an optical imaging system 200 may include a first lens 210, a second lens 220, a third lens 230, a fourth lens 240, a fifth lens 250, a sixth lens 260, a seventh lens 270, and an eighth lens 280, sequentially arranged from an object side, and may further include an infrared cut-off filter F and an image sensor (an imaging plane (IP)), arranged on an image side of the eighth lens 280. Additionally, the optical imaging system 200 may further include a stop ST disposed between the third lens 230 and the fourth lens 240.

The first lens 210 may have a positive refractive power. An object-side surface of the first lens 210 may be convex in a paraxial region, and an image-side surface of the first lens 210 may be concave in the paraxial region. The first lens 210 may be formed of a plastic material. Additionally, the first lens 210 may be an aspherical lens. For example, the first lens 210 may be a double-sided aspherical lens in which both the object-side surface and the image-side surface are aspherical.

The second lens 220 may have a negative refractive power. An object-side surface of the second lens 220 may be convex in a paraxial region, and an image-side surface of the second lens 220 may be concave in the paraxial region. The second lens 220 may be formed of a plastic material. For example, the second lens 220 may be formed of a plastic material having different optical properties (e.g., a different refractive index and Abbe number) than the first lens 210, and in an example, an Abbe number of the second lens 220 may be less than 20. Additionally, the second lens 220 may be an aspherical lens. For example, the second lens 220 may be a double-sided aspherical lens in which both the object-side surface and the image-side surface are aspherical.

The third lens 230 may have a positive refractive power. An object-side surface of the third lens 230 may be convex in a paraxial region, and an image-side surface of the third lens 230 may be concave in the paraxial region. The third lens 230 may be formed of a plastic material. For example, the third lens 230 may be formed of a plastic material having different optical properties (e.g., a different refractive index and Abbe number) than the second lens 220. Additionally, the third lens 230 may be an aspherical lens. For example, the third lens 230 may be a double-sided aspherical lens in which both the object-side surface and the image-side surface are aspherical.

The fourth lens 240 may have a positive refractive power. An object-side surface of the fourth lens 240 may be concave in a paraxial region, and an image-side surface of the fourth lens 240 may be convex in the paraxial region. The fourth lens 240 may be formed of a plastic material. For example, the fourth lens 240 may be formed of a plastic material having different optical properties (e.g., a different refractive index and Abbe number) than the third lens 230. Additionally, the fourth lens 240 may be an aspherical lens. For example, the fourth lens 240 may be a double-sided aspherical lens in which both the object-side surface and the image-side surface are aspherical.

The fifth lens 250 may have a negative refractive power. An object-side surface of the fifth lens 250 may be convex in a paraxial region, and an image-side surface of the fifth lens 250 may be concave in the paraxial region. The fifth lens 250 may be formed of a plastic material. For example, the fifth lens 250 may be formed of a plastic material having different optical properties (e.g., a different refractive index and Abbe number) than the fourth lens 240, and in an example, an Abbe number of the fifth lens 250 may be less than 20. Additionally, the fifth lens 250 may be an aspherical lens. For example, the fifth lens 250 may be a double-sided aspherical lens in which both the object-side surface and the image-side surface are aspherical.

The sixth lens 260 may have a negative refractive power. An object-side surface of the sixth lens 260 may be convex in a paraxial region, and an image-side surface of the sixth lens 260 may be concave in the paraxial region. The sixth lens 260 may be formed of a plastic material. For example, the sixth lens 260 may be formed of a plastic material having different optical properties (e.g., a different refractive index and Abbe number) than the fifth lens 250. Additionally, the sixth lens 260 may be an aspherical lens. For example, the sixth lens 260 may be a double-sided aspherical lens in which both the object-side surface and the image-side surface are aspherical.

The seventh lens 270 may have a positive refractive power. An object-side surface of the seventh lens 270 may be convex in a paraxial region, and an image-side surface of the seventh lens 270 may be concave in the paraxial region. The seventh lens 270 may be formed of a plastic material. For example, the seventh lens 270 may be formed of a plastic material having different optical properties (e.g., a different refractive index and Abbe number) than the sixth lens 260. Additionally, the seventh lens 270 may be an aspherical lens. For example, the seventh lens 270 may be a double-sided aspherical lens in which both the object-side surface and the image-side surface are aspherical.

The eighth lens 280 may have a negative refractive power. An object-side surface of the eighth lens 280 may be convex in a paraxial region, and an image-side surface of the eighth lens 280 may be concave in the paraxial region. The eighth lens 280 may be formed of a plastic material. For example, the eighth lens 280 may be formed of a plastic material having different optical properties (e.g., a different refractive index and Abbe number) than the seventh lens 270. Additionally, the eighth lens 280 may be an aspherical lens. For example, the eighth lens 280 may be a double-sided aspherical lens in which both the object-side surface and the image-side surface are aspherical.

Table 3 below illustrates optical and physical parameters of the optical imaging system 200 according to the second embodiment of the present disclosure.

TABLE 3

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.438 | 1.043 | 1.546 | 55.990 | 1.945 |
| 2 | 12.306 | 0.050 | | | 1.892 |
| 3 | 10.421 | 0.220 | 1.677 | 19.238 | 1.812 |
| 4 | 4.559 | 0.316 | | | 1.649 |
| 5 | 7.626 | 0.353 | 1.570 | 37.403 | 1.621 |
| 6 | 11.888 | 0.127 | | | 1.538 |
| STOP | Infinity | 0.234 | | | 1.504 |
| 7 | −30.155 | 0.318 | 1.546 | 55.990 | 1.551 |
| 8 | −13.676 | 0.263 | | | 1.704 |
| 9 | 11.931 | 0.220 | 1.677 | 19.238 | 1.802 |
| 10 | 7.554 | 0.603 | | | 2.067 |
| 11 | 31.022 | 0.400 | 1.570 | 37.403 | 2.352 |
| 12 | 16.981 | 0.186 | | | 2.696 |
| 13 | 2.635 | 0.500 | 1.546 | 55.990 | 3.358 |
| 14 | 4.977 | 0.816 | | | 3.601 |
| 15 | 30.989 | 0.500 | 1.537 | 55.735 | 4.274 |
| 16 | 2.637 | 0.500 | | | 4.483 |
| 17 | Infinity | 0.210 | 1.518 | 64.197 | |
| 18 | Infinity | 0.341 | | | |
| Image | Infinity | | | | |

Table 4 below illustrates aspheric data of the optical imaging system 200 according to the second embodiment of the present disclosure.

TABLE 4

| Surface | 1 | 2 | 3 | 4 | 5 | 6 | 8 | 9 |
|---|---|---|---|---|---|---|---|---|
| K | −7.41E−01 | −8.29E+01 | 2.30E+01 | 3.09E+00 | 1.91E+01 | 5.03E+01 | 9.00E+01 | 3.91E+01 |
| A | −6.40E−03 | 9.24E−03 | −1.56E−03 | −1.01E−02 | −1.98E−02 | −1.66e−02 | 2.59E−02 | 1.58E−02 |
| B | 3.18E−02 | −1.89E−02 | −7.12E−03 | 2.63E−02 | 2.01E−02 | 9.49E−03 | −1.11E−01 | −3.99E−02 |
| C | −4.50E−02 | 1.51E−02 | −2.96E−03 | −5.42E−02 | −5.96E−02 | −1.99E−02 | 2.33E−01 | 7.34E−02 |
| D | 3.85E−02 | −5.21E−03 | 1.86E−02 | 6.93E−02 | 8.81E−02 | 2.63E−03 | −3.52E−01 | −1.19E−01 |
| E | −2.07E−02 | −1.90E−04 | −1.89E−02 | −5.16E−02 | −7.75E−02 | 2.34E−02 | 3.35E−01 | 1.16E−01 |
| F | 6.94E−03 | 8.11E−04 | 9.75E−03 | 2.37E−02 | 4.34E−02 | −2.70E−02 | −2.01E−01 | −6.82E−02 |
| G | −1.42E−03 | −3.00E−04 | −2.86E−03 | −6.58E−03 | −1.49E−02 | 1.41E−02 | 7.37E−02 | 2.42E−02 |
| H | 1.60E−04 | 4.98E−05 | 4.53E−04 | 1.04E−03 | 2.90E−03 | −3.67E−03 | −1.51E−02 | −4.76E−03 |
| J | −7.57E−06 | −3.27E−06 | −3.02E−05 | −7.37E−05 | −2.43E−04 | 3.88E−04 | 1.33E−03 | 3.96E−04 |
| Surface | 10 | 11 | 12 | 13 | 14 | 15 | 16 | 17 |
| K | −6.91E+01 | −6.96E+01 | −8.75E+01 | −9.00E+01 | −9.35E+00 | −3.97E+01 | 1.17E+01 | −1.23E+01 |
| A | −3.84E−02 | −4.74E−02 | −9.43E−03 | −4.95E−02 | 8.51E−02 | 4.08E−02 | −1.29E−01 | −6.45E−02 |
| B | −1.44E−02 | 3.97E−02 | 1.06E−02 | 1.73E−02 | −1.83E−03 | −2.90E−02 | 4.27E−02 | 1.84E−02 |
| C | 4.51E−02 | −6.66E−02 | −3.36E−02 | −1.94E−02 | 1.00E−03 | 6.28E−03 | −8.61E−03 | −3.63E−03 |
| D | −6.32E−02 | 7.04E−02 | 3.30E−02 | 1.40E−02 | 1.09E−03 | −4.80E−04 | 1.15E−03 | 4.97E−04 |
| E | 5.10E−02 | −4.67E−02 | −1.82E−02 | −5.94E−03 | −3.43E−04 | −6.74E05 | −1.02E−04 | −4.57E−05 |
| F | −2.63E−02 | 1.90E−02 | 6.00E−03 | 1.48E−03 | 5.17E−05 | 1.91E−05 | 5.96E−06 | 2.72E−06 |
| G | 8.37E−03 | −4.65E−03 | −1.17E−03 | −2.12E−04 | −4.36E−06 | −1.81E−06 | −2.17E−07 | −1.00E−07 |
| H | −1.48E−03 | 6.24E−04 | 1.25E−04 | 1.60E−05 | 1.96E−07 | 8.02E−08 | 4.53E−09 | 2.10E−09 |
| J | 1.10E−04 | −3.53E−05 | −5.54E−06 | −4.96E−07 | −3.66E−09 | −1.39E−09 | −4.14E−11 | −1.92E−11 |

### Third Embodiment

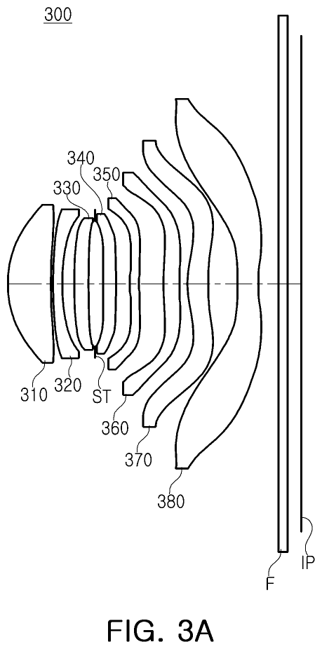

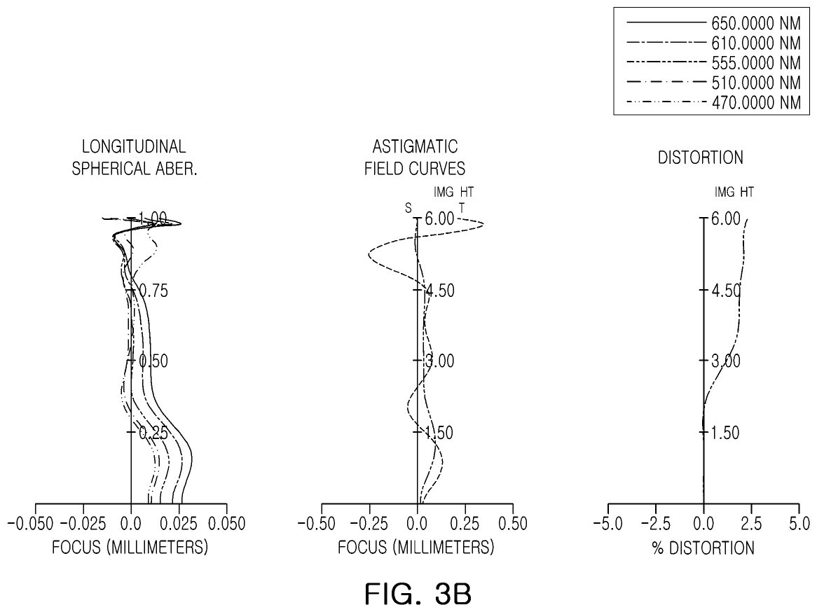

FIG. 3A is a configuration diagram of an optical imaging system according to a third embodiment of the present disclosure. FIG. 3B are graphs illustrating the aberration characteristics of the optical imaging system according to the third embodiment of the present disclosure.

According to the third embodiment, an optical imaging system 300 may include a first lens 310, a second lens 320, a third lens 330, a fourth lens 340, a fifth lens 350, a sixth lens 360, a seventh lens 370, and an eighth lens 380, sequentially arranged from an object side, and may further include an infrared cut-off filter F and an image sensor (an imaging plane (IP)), arranged on an image side of the eighth lens 380. Additionally, the optical imaging system 300 may further include a stop ST disposed between the third lens 330 and the fourth lens 340.

The first lens 310 may have a positive refractive power. An object-side surface of the first lens 310 may be convex in a paraxial region, and an image-side surface of the first lens 310 may be concave in the paraxial region. The first lens 310 may be formed of a plastic material. Additionally, the first lens 310 may be an aspherical lens. For example, the first lens 310 may be a double-sided aspherical lens in which both the object-side surface and the image-side surface are aspherical.

The second lens 320 may have a negative refractive power. An object-side surface of the second lens 320 may be convex in a paraxial region, and an image-side surface of the second lens 320 may be concave in the paraxial region. The second lens 320 may be formed of a plastic material. For example, the second lens 320 may be formed of a plastic material having different optical properties (e.g., a different refractive index and Abbe number) than the first lens 310, and in an example, an Abbe number of the second lens 320 may be less than 20. Additionally, the second lens 320 may be an aspherical lens. For example, the second lens 320 may be a double-sided aspherical lens in which both the object-side surface and the image-side surface are aspherical.

The third lens 330 may have a positive refractive power. An object-side surface of the third lens 330 may be convex in a paraxial region, and an image-side surface of the third lens 330 may be concave in the paraxial region. The third lens 330 may be formed of a plastic material. For example, the third lens 330 may be formed of a plastic material with different optical properties (e.g., a different refractive index and Abbe number) than the second lens 320. Additionally, the third lens 330 may be an aspherical lens. For example, the third lens 330 may be a double-sided aspherical lens in which both the object-side surface and the image-side surface are aspherical.

The fourth lens 340 may have a positive refractive power. An object-side surface of the fourth lens 340 may be concave in a paraxial region, and an image-side surface of the fourth lens 340 may be convex in the paraxial region. The fourth lens 340 may be formed of a plastic material. For example, the fourth lens 340 may be formed of a plastic material having different optical properties (e.g., a different refractive index and Abbe number) than the third lens 330. Additionally, the fourth lens 340 may be an aspherical lens. For example, the fourth lens 340 may be a double-sided aspherical lens in which both the object-side surface and the image-side surface are aspherical.

The fifth lens 350 may have a negative refractive power. An object-side surface of the fifth lens 350 may be convex in a paraxial region, and an image-side surface of the fifth lens 350 may be concave in the paraxial region. The fifth lens 350 may be formed of a plastic material. For example, the fifth lens 350 may be formed of a plastic material having different optical properties (e.g., a different refractive index and Abbe number) than the fourth lens 340, and in an example, an Abbe number of the fifth lens 350 may be less than 20. Additionally, the fifth lens 350 may be an aspherical lens. For example, the fifth lens 350 may be a double-sided aspherical lens in which both the object-side surface and the image-side surface are aspherical.

The sixth lens 360 may have a negative refractive power. An object-side surface of the sixth lens 360 may be convex in a paraxial region, and an image-side surface of the sixth lens 360 may be concave in the paraxial region. The sixth lens 360 may be formed of a plastic material. For example, the sixth lens 360 may be formed of a plastic material having different optical properties (e.g., a different refractive index and Abbe number) than the fifth lens 350. Additionally, the sixth lens 360 may be an aspherical lens. For example, the sixth lens 360 may be a double-sided aspherical lens in which both the object-side surface and the image-side surface are aspherical.

The seventh lens 370 may have a positive refractive power. An object-side surface of the seventh lens 370 may be convex in a paraxial region, and an image-side surface of the seventh lens 370 may be concave in the paraxial region. The seventh lens 370 may be formed of a plastic material. For example, the seventh lens 370 may be formed of a plastic material having different optical properties (e.g., a different refractive index and Abbe number) than the sixth lens 360. Additionally, the seventh lens 370 may be an aspherical lens. For example, the seventh lens 370 may be a double-sided aspherical lens in which both the object-side surface and the image-side surface are aspherical.

The eighth lens 380 may have a negative refractive power. An object-side surface of the eighth lens 380 may be convex in a paraxial region, and an image-side surface of the eighth lens 380 may be concave in the paraxial region. The eighth lens 380 may be formed of a plastic material. For example, the eighth lens 380 may be formed of a plastic material having different optical properties (e.g., a different refractive index and Abbe number) than the seventh lens 370. Additionally, the eighth lens 380 may be an aspherical lens. For example, the eighth lens 380 may be a double-sided aspherical lens in which both the object-side surface and the image-side surface are aspherical.

Table 5 below illustrates optical and physical parameters of the optical imaging system 300 according to the third embodiment of the present disclosure.

TABLE 5

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.373 | 1.032 | 1.546 | 55.990 | 1.910 |
| 2 | 12.120 | 0.050 | | | 1.859 |
| 3 | 10.560 | 0.220 | 1.677 | 19.238 | 1.781 |
| 4 | 4.410 | 0.285 | | | 1.618 |
| 5 | 7.202 | 0.354 | 1.570 | 37.403 | 1.589 |
| 6 | 11.206 | 0.152 | | | 1.502 |
| STOP | Infinity | 0.201 | | | 1.473 |
| 7 | −83.122 | 0.303 | 1.546 | 55.990 | 1.522 |
| 8 | −21.143 | 0.353 | | | 1.687 |
| 9 | 9.757 | 0.220 | 1.677 | 19.238 | 1.799 |
| 10 | 6.751 | 0.590 | | | 2.070 |
| 11 | 9.890 | 0.390 | 1.570 | 37.403 | 2.360 |
| 12 | 9.715 | 0.199 | | | 2.705 |
| 13 | 3.122 | 0.490 | 1.546 | 55.990 | 3.217 |
| 14 | 5.900 | 0.704 | | | 3.455 |
| 15 | 94.866 | 0.494 | 1.537 | 55.735 | 4.278 |
| 16 | 2.734 | 0.500 | | | 4.457 |
| 17 | Infinity | 0.210 | 1.518 | 64.197 | |
| 18 | Infinity | 0.334 | | | |
| Image | Infinity | | | | |

Table 6 below illustrates aspheric data of the optical imaging system 300 according to the third embodiment of the present disclosure.

TABLE 6

| Surface | 1 | 2 | 3 | 4 | 5 | 6 | 8 | 9 |
|---|---|---|---|---|---|---|---|---|
| K | −7.71E−01 | −9.00E+01 | 2.37E+01 | 3.03E+00 | 1.80E+01 | 5.02E+01 | −3.96E+01 | 9.00E+01 |
| A | −7.06E−03 | 8.53E−03 | −7.56E−03 | −2.38E−02 | −2.29E−02 | −2.75E−02 | 3.77E−03 | −2.04E−03 |
| B | 3.32E−02 | −1.82E−02 | 8.27E−03 | 7.39E−02 | 2.85E−02 | 6.53E−02 | −2.79E−02 | 1.11E−02 |
| C | −4.58E−02 | 1.52E−02 | −2.47E−02 | −1.52E−01 | −8.75E−02 | −1.87E−01 | 2.28E−02 | −5.20E−02 |
| D | 3.86E−02 | −6.46E−03 | 3.81E−02 | 1.89E−01 | 1.36E−01 | 2.90E−01 | −3.67E−02 | 6.59E−02 |
| E | −2.06E−02 | 1.26E−03 | −2.97E−02 | −1.41E−01 | −1.25E−01 | −2.79E−01 | 4.13E−02 | −5.36E−02 |
| F | 6.88E−03 | 2.07E−05 | 1.36E−02 | 6.47E−02 | 7.25E−02 | 1.70E−01 | −2.85E−02 | 2.81E−02 |
| G | −1.40E−03 | −7.82E−05 | −3.78E−03 | −1.76E−02 | −2.58E−02 | −6.41E−02 | 1.20E−02 | −8.85E−03 |
| H | 1.57E−04 | 1.90E−05 | 5.87E−04 | 2.55E−03 | 5.13E−03 | 1.35E−02 | −2.82E−03 | 1.51E−03 |
| J | −7.38E−06 | −1.62E−06 | −3.90E−05 | −1.50E−04 | −4.42E−04 | −1.21E−03 | 2.84E−04 | −1.04E−04 |
| Surface | 10 | 11 | 12 | 13 | 14 | 15 | 16 | 17 |
| K | −7.50E+01 | −7.26E+01 | −8.58E+01 | −5.86E+01 | −1.06E+01 | −6.45E+01 | 9.00E+01 | −1.40E+01 |
| A | −4.40E−02 | −5.01E−02 | −2.24E−02 | −4.27E−02 | 1.02E−02 | 4.55E−02 | −1.33E−01 | −6.95E−02 |
| B | −1.77E−03 | 3.91E−02 | 1.65E−02 | 3.01E−03 | −2.39E−02 | −3.58E−02 | 4.69E−02 | 2.00E−02 |
| C | 3.64E−02 | −5.41E−02 | −3.20E−02 | −7.49E−03 | 1.36E−03 | 8.48E−03 | −9.92E−03 | −3.84E−03 |
| D | −6.49E−02 | 5.16E−02 | 2.87E−02 | 7.58E−03 | 1.74E−03 | −7.79E−04 | 1.39E−03 | 5.37E−04 |
| E | 5.72E−02 | −3.36E−02 | −1.55E−02 | −3.76E−03 | −5.99E−04 | −7.52E−05 | −1.28E−04 | −5.33E−05 |
| F | −3.06E−02 | 1.39E−02 | 5.12E−03 | 1.02E−03 | 9.88E−05 | 2.70E−05 | 7.75E−06 | 3.56E−06 |
| G | 9.84E−03 | −3.49E−03 | −1.01E−03 | −1.53E−04 | −9.14E−06 | −2.82E−06 | −2.93E−07 | −1.49E−07 |
| H | −1.74E−03 | 4.86E−04 | 1.10E−04 | 1.20E−05 | 4.52E−07 | 1.34E−07 | 6.33E−09 | 3.57E−09 |
| J | 1.30E−04 | −2.86E−05 | −5.02E−06 | −3.80E−07 | −9.28E−09 | −2.50E−09 | −5.94E−11 | −3.68E−11 |

### Fourth Embodiment

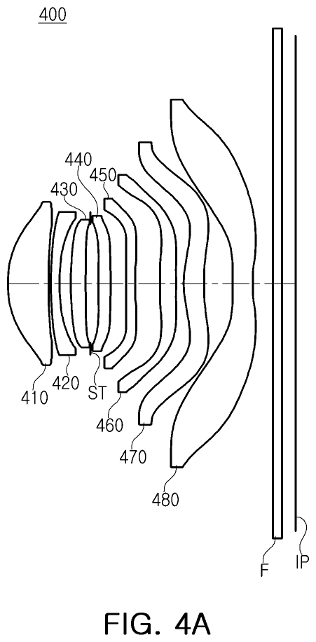

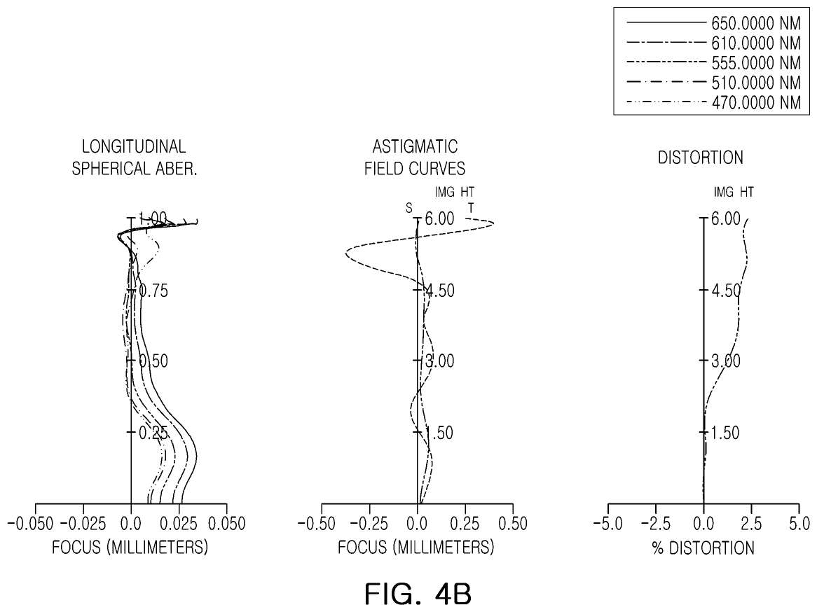

FIG. 4A is a configuration diagram of an optical imaging system according to a fourth embodiment of the present disclosure. FIG. 4B are graphs illustrating the aberration characteristics of the optical imaging system according to the fourth embodiment of the present disclosure.

According to the fourth embodiment, an optical imaging system 400 may include a first lens 410, a second lens 420, a third lens 430, a fourth lens 440, a fifth lens 450, a sixth lens 460, a seventh lens 470, and an eighth lens 480, sequentially arranged from an object side, and may further include an infrared cut-off filter F and an image sensor (an imaging plane (IP)), arranged on an image side of the eighth lens 480. Additionally, the optical imaging system 400 may further include a stop ST disposed between the third lens 430 and the fourth lens 440.

The first lens 410 may have a positive refractive power. An object-side surface of the first lens 410 may be convex in a paraxial region, and an image-side surface of the first lens 410 may be concave in the paraxial region. The first lens 410 may be formed of a plastic material. Additionally, the first lens 410 may be an aspherical lens. For example, the first lens 410 may be a double-sided aspherical lens in which both the object-side surface and the image-side surface are aspherical.

The second lens 420 may have a negative refractive power. An object-side surface of the second lens 420 may be convex in a paraxial region, and an image-side surface of the second lens 420 may be concave in the paraxial region. The second lens 420 may be formed of a plastic material. For example, the second lens 420 may be formed of a plastic material having different optical properties (e.g., a different refractive index and Abbe number) than the first lens 410, and in an example, an Abbe number of the second lens 420 may be less than 20. Additionally, the second lens 420 may be an aspherical lens. For example, the second lens 420 may be a double-sided aspherical lens in which both the object-side surface and the image-side surface are aspherical.

The third lens 430 may have a positive refractive power. An object-side surface of the third lens 430 may be convex in a paraxial region, and an image-side surface of the third lens 430 may be concave in the paraxial region. The third lens 430 may be formed of a plastic material. For example, the third lens 430 may be formed of a plastic material having different optical properties (e.g., a different refractive index and Abbe number) than the second lens 420. Additionally, the third lens 430 may be an aspherical lens. For example, the third lens 430 may be a double-sided aspherical lens in which both the object-side surface and the image-side surface are aspherical.

The fourth lens 440 may have a positive refractive power. An object-side surface of the fourth lens 440 may be concave in a paraxial region, and an image-side surface of the fourth lens 440 may be convex in the paraxial region. The fourth lens 440 may be formed of a plastic material. For example, the fourth lens 440 may be formed of a plastic material having different optical properties (e.g., a different refractive index and Abbe number) than the third lens 430. Additionally, the fourth lens 440 may be an aspherical lens. For example, the fourth lens 440 may be a double-sided aspherical lens in which both the object-side surface and the image-side surface are aspherical.

The fifth lens 450 may have a negative refractive power. An object-side surface of the fifth lens 450 may be convex in a paraxial region, and an image-side surface of the fifth lens 450 may be concave in the paraxial region. The fifth lens 450 may be formed of a plastic material. For example, the fifth lens 450 may be formed of a plastic material having different optical properties (e.g., a different refractive index and Abbe number) than the fourth lens 440, and in an example, an Abbe number of the fifth lens 450 may be less than 20. Additionally, the fifth lens 450 may be an aspherical lens. For example, the fifth lens 450 may be a double-sided aspherical lens in which both the object-side surface and the image-side surface are aspherical.

The sixth lens 460 may have a positive refractive power. An object-side surface of the sixth lens 460 may be convex in a paraxial region, and an image-side surface of the sixth lens 460 may be concave in the paraxial region. The sixth lens 460 may be formed of a plastic material. For example, the sixth lens 460 may be formed of a plastic material having different optical properties (e.g., a different refractive index and Abbe number) than the fifth lens 450. Additionally, the sixth lens 460 may be an aspherical lens. For example, the sixth lens 460 may be a double-sided aspherical lens in which both the object-side surface and the image-side surface are aspherical.

The seventh lens 470 may have a positive refractive power. An object-side surface of the seventh lens 470 may be convex in a paraxial region, and an image-side surface of the seventh lens 470 may be concave in the paraxial region. The seventh lens 470 may be formed of a plastic material. For example, the seventh lens 470 may be formed of a plastic material having different optical properties (e.g., a different refractive index and Abbe number) than the sixth lens 460. Additionally, the seventh lens 470 may be an aspherical lens. For example, the seventh lens 470 may be a double-sided aspherical lens in which both the object-side surface and the image-side surface are aspherical.

The eighth lens 480 may have a negative refractive power. An object-side surface of the eighth lens 480 may be convex in a paraxial region, and an image-side surface of the eighth lens 480 may be concave in the paraxial region. The eighth lens 480 may be formed of a plastic material. For example, the eighth lens 480 may be formed of a plastic material having different optical properties (e.g., a different refractive index and Abbe number) than the seventh lens 470. Additionally, the eighth lens 480 may be an aspherical lens. For example, the eighth lens 480 may be a double-sided aspherical lens in which both the object-side surface and the image-side surface are aspherical.

Table 7 below illustrates optical and physical parameters of the optical imaging system 400 according to the fourth embodiment of the present disclosure.

TABLE 7

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.332 | 0.988 | 1.546 | 55.990 | 1.844 |
| 2 | 11.579 | 0.050 | | | 1.790 |
| 3 | 10.158 | 0.220 | 1.677 | 19.238 | 1.720 |
| 4 | 4.283 | 0.269 | | | 1.564 |
| 5 | 6.923 | 0.342 | 1.570 | 37.403 | 1.536 |
| 6 | 10.722 | 0.145 | | | 1.444 |
| STOP | Infinity | 0.191 | | | 1.428 |
| 7 | −81.376 | 0.284 | 1.546 | 55.990 | 1.473 |
| 8 | −22.406 | 0.373 | | | 1.644 |
| 9 | 7.846 | 0.220 | 1.677 | 19.238 | 1.776 |
| 10 | 5.812 | 0.605 | | | 2.055 |
| 11 | 9.196 | 0.380 | 1.570 | 37.403 | 2.365 |
| 12 | 9.169 | 0.205 | | | 2.631 |
| 13 | 3.031 | 0.480 | 1.546 | 55.990 | 3.189 |
| 14 | 5.897 | 0.694 | | | 3.417 |
| 15 | 409.111 | 0.480 | 1.537 | 55.735 | 4.238 |
| 16 | 2.736 | 0.500 | | | 4.435 |
| 17 | Infinity | 0.210 | 1.518 | 64.197 | |
| 18 | Infinity | 0.324 | | | |
| Image | Infinity | | | | |

Table 8 below illustrates aspheric data of the optical imaging system 400 according to the fourth embodiment of the present disclosure.

TABLE 8

| Surface | 1 | 2 | 3 | 4 | 5 | 6 | 8 | 9 |
|---|---|---|---|---|---|---|---|---|
| K | −7.75E−01 | −8.60E+01 | 2.73E+01 | 3.06E+00 | 1.79E+01 | 4.88E+01 | 5.43E+01 | 9.00E+01 |
| A | −2.60E−03 | 4.86E−03 | −1.27E−02 | −2.02E−02 | −2.65E−02 | −2.63E−02 | −4.81E−03 | −7.98E−03 |
| B | 2.51E−02 | −6.79E−03 | 2.50E−02 | 6.30E−02 | 4.88E−02 | 7.22E−02 | 8.99E−03 | 2.69E−02 |
| C | −3.59E−02 | −3.28E−03 | −5.82E−02 | −1.39E−01 | −1.47E−01 | −2.33E−01 | −1.02E−01 | −9.53E−02 |
| D | 3.11E−02 | 1.24E−02 | 8.14E−02 | 1.81E−01 | 2.32E−01 | 3.96E−01 | 2.16E−01 | 1.40E−01 |
| E | −1.68E−02 | −1.08E−02 | −6.40E−02 | 1.34E−01 | −2.19E−01 | −4.09E−01 | −2.63E−01 | −1.31E−01 |
| F | 5.65E−03 | 4.74E−03 | 3.02E−02 | 5.64E−02 | 1.32E−01 | 2.68E−01 | 1.91E−01 | 7.77E−02 |
| G | −1.14E−03 | −1.20E−03 | −8.61E−03 | −1.24E−02 | −4.91E−02 | −1.08E−01 | −8.15E−02 | −2.78E−02 |
| H | 1.21E−04 | 1.67E−04 | 1.37E−03 | 9.90E−04 | 1.04E−02 | 2.44E−02 | 1.88E−02 | 5.45E−03 |
| J | −5.08E−06 | −1.01E−05 | −9.30E−05 | 3.08E−05 | −9.61E−04 | −2.38E−03 | −1.81E−03 | −4.48E−04 |
| Surface | 10 | 11 | 12 | 13 | 14 | 15 | 16 | 17 |
| K | −8.28E+01 | −7.05E+01 | −8.70E+01 | −7.45E+01 | −1.04E+01 | −6.37E+01 | 9.00E+01 | −1.43E+01 |
| A | −4.06E−02 | −4.48E−02 | −2.00E−02 | −4.62E−02 | 1.08E−02 | 4.83E−02 | −1.38E−01 | −7.32E−02 |
| B | −2.04E−02 | 2.92E−02 | 6.65E−03 | 2.83E−03 | −2.59E−02 | −3.97E−02 | 4.88E−02 | 2.13E−02 |
| C | 7.77E−02 | −4.67E−02 | −1.69E−02 | −6.31E−03 | 1.51E−03 | 9.86E−03 | −1.02E−02 | −4.03E−03 |
| D | −1.23E−01 | 4.87E−02 | 1.52E−02 | 6.24E−03 | 2.01E−03 | −1.00E−03 | 1.40E−03 | 5.60E−04 |
| E | 1.09E−01 | −3.31E−02 | −8.23E−03 | −3.5E−03 | −7.12E−04 | −7.42E−05 | −1.28E−04 | −5.62E−05 |
| F | −5.93E−02 | 1.39E−02 | 2.75E−03 | 8.31E−04 | 1.21E−04 | 3.20E−05 | 7.68E−06 | 3.82E−06 |
| G | 1.94E−02 | −3.50E−03 | −5.61E−04 | −1.26E−04 | −1.15E−05 | −3.53E−06 | −2.89E−07 | −1.64E−07 |
| H | −3.51E−03 | 4.90E−04 | 6.34E−05 | 9.87E−06 | 5.84E−07 | 1.76E−07 | 6.22E−09 | 4.01E−09 |
| J | 2.69E−04 | −2.91E−05 | −3.01E−06 | −3.15E−07 | −1.23E−08 | −3.42E−09 | −5.83E−11 | −4.21E−11 |

### Fifth Embodiment

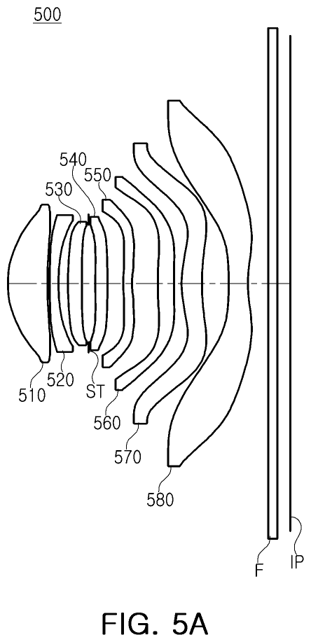

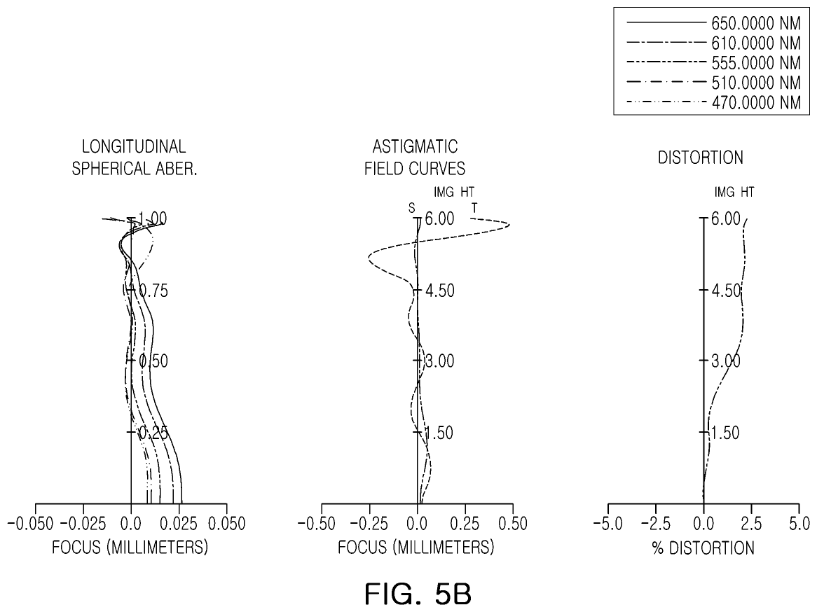

FIG. 5A is a configuration diagram of an optical imaging system according to a fifth embodiment of the present disclosure. FIG. 5B are graphs illustrating the aberration characteristics of the optical imaging system according to the fifth embodiment of the present disclosure.

According to the fifth embodiment, an optical imaging system 500 may include a first lens 510, a second lens 520, a third lens 530, a fourth lens 540, a fifth lens 550, a sixth lens 560, a seventh lens 570, and an eighth lens 580, sequentially arranged from an object side, and may further include an infrared cut-off filter F and an image sensor (an imaging plane (IP)), arranged on an image side of the eighth lens 580. Additionally, the optical imaging system 500 may further include a stop ST disposed between the third lens 530 and the fourth lens 540.

The first lens 510 may have a positive refractive power. An object-side surface of the first lens 510 may be convex in a paraxial region, and an image-side surface of the first lens 510 may be concave in the paraxial region. The first lens 510 may be formed of a plastic material. Additionally, the first lens 510 may be an aspherical lens. For example, the first lens 510 may be a double-sided aspherical lens in which both the object-side surface and the image-side surface are aspherical.

The second lens 520 may have a negative refractive power. An object-side surface of the second lens 520 may be convex in a paraxial region, and an image-side surface of the second lens 520 may be concave in the paraxial region. The second lens 520 may be formed of a plastic material. For example, the second lens 520 may be formed of a plastic material having different optical properties (e.g., a different refractive index and Abbe number) than the first lens 510, and in an example, an Abbe number of the second lens 520 may be less than 20. Additionally, the second lens 520 may be an aspherical lens. For example, the second lens 520 may be a double-sided aspherical lens in which both the object-side surface and the image-side surface are aspherical.

The third lens 530 may have a positive refractive power. An object-side surface of the third lens 530 may be convex in a paraxial region, and an image-side surface of the third lens 530 may be concave in the paraxial region. The third lens 530 may be formed of a plastic material. For example, the third lens 530 may be formed of a plastic material having different optical properties (e.g., a different refractive index and Abbe number) than the second lens 520. Additionally, the third lens 530 may be an aspherical lens. For example, the third lens 530 may be a double-sided aspherical lens in which both the object-side surface and the image-side surface are aspherical.

The fourth lens 540 may have a positive refractive power. Both an object-side surface and an image-side surface of the fourth lens 540 may be convex in a paraxial region. The fourth lens 540 may be formed of a plastic material. For example, the fourth lens 540 may be formed of a plastic material having different optical properties (e.g., a different refractive index and Abbe number) than the third lens 530. Additionally, the fourth lens 540 may be an aspherical lens. For example, the fourth lens 540 may be a double-sided aspherical lens in which both the object-side surface and the image-side surface are aspherical.

The fifth lens 550 may have a negative refractive power. An object-side surface of the fifth lens 550 may be convex in a paraxial region, and an image-side surface of the fifth lens 550 may be concave in the paraxial region. The fifth lens 550 may be formed of a plastic material. For example, the fifth lens 550 may be formed of a plastic material having different optical properties (e.g., a different refractive index and Abbe number) than the fourth lens 540, and in an example, an Abbe number of the fifth lens 550 may be less than 20. Additionally, the fifth lens 550 may be an aspherical lens. For example, the fifth lens 550 may be a double-sided aspherical lens in which both the object-side surface and the image-side surface are aspherical.

The sixth lens 560 may have a negative refractive power. An object-side surface of the sixth lens 560 may be convex in a paraxial region, and an image-side surface of the sixth lens 560 may be concave in the paraxial region. The sixth lens 560 may be formed of a plastic material. For example, the sixth lens 560 may be formed of a plastic material having different optical properties (e.g., a different refractive index and Abbe number) than the fifth lens 550. Additionally, the sixth lens 560 may be an aspherical lens. For example, the sixth lens 560 may be a double-sided aspherical lens in which both the object-side surface and the image-side surface are aspherical.

The seventh lens 570 may have a positive refractive power. An object-side surface of the seventh lens 570 may be convex in a paraxial region, and an image-side surface of the seventh lens 570 may be concave in the paraxial region. The seventh lens 570 may be formed of a plastic material. For example, the seventh lens 570 may be formed of a plastic material having different optical properties (e.g., a different refractive index and Abbe number) than the sixth lens 560. Additionally, the seventh lens 570 may be an aspherical lens. For example, the seventh lens 570 may be a double-sided aspherical lens in which both the object-side surface and the image-side surface are aspherical.

The eighth lens 580 may have a negative refractive power. An object-side surface of the eighth lens 580 may be convex in a paraxial region, and an image-side surface of the eighth lens 580 may be concave in the paraxial region. The eighth lens 580 may be formed of a plastic material. For example, the eighth lens 580 may be formed of a plastic material having different optical properties (e.g., a different refractive index and Abbe number) than the seventh lens 570. Additionally, the eighth lens 580 may be an aspherical lens. For example, the eighth lens 580 may be a double-sided aspherical lens in which both the object-side surface and the image-side surface are aspherical.

Table 9 below illustrates optical and physical parameters of the optical imaging system 500 according to the fifth embodiment of the present disclosure.

TABLE 9

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.487 | 1.070 | 1.546 | 55.990 | 1.781 |
| 2 | 11.889 | 0.050 | | | 1.726 |
| 3 | 10.188 | 0.220 | 1.677 | 19.238 | 1.665 |
| 4 | 4.720 | 0.304 | | | 1.519 |
| 5 | 8.191 | 0.315 | 1.570 | 37.403 | 1.492 |
| 6 | 11.866 | 0.140 | | | 1.401 |
| STOP | Infinity | 0.237 | | | 1.386 |
| 7 | −27.704 | 0.417 | 1.546 | 55.990 | 1.430 |
| 8 | −10.738 | 0.156 | | | 1.602 |
| 9 | 28.760 | 0.220 | 1.677 | 19.238 | 1.743 |
| 10 | 10.926 | 0.535 | | | 2.014 |
| 11 | 36.482 | 0.400 | 1.570 | 37.403 | 2.319 |
| 12 | 24.474 | 0.318 | | | 2.568 |
| 13 | 2.926 | 0.500 | 1.546 | 55.990 | 3.102 |
| 14 | 6.872 | 0.859 | | | 3.325 |
| 15 | 23.402 | 0.500 | 1.537 | 55.735 | 4.232 |
| 16 | 2.396 | 0.500 | | | 4.430 |
| 17 | Infinity | 0.210 | 1.518 | 64.197 | |
| 18 | Infinity | 0.369 | | | |
| Image | Infinity | | | | |

Table 10 below illustrates aspheric data of the optical imaging system 500 according to the fifth embodiment of the present disclosure.

TABLE 10

| Surface | 1 | 2 | 3 | 4 | 5 | 6 | 8 | 9 |
|---|---|---|---|---|---|---|---|---|
| K | −8.29E−01 | −9.00E+01 | 2.51E+01 | 2.82E+00 | 1.73E+01 | 4.67E+01 | −5.80E+01 | 9.00E+01 |
| A | −2.61E−03 | −7.60E−03 | −2.42E−02 | 2.64E−02 | −3.14E−02 | −3.96E−02 | −2.74E−02 | −2.95E−02 |
| B | 2.65E−02 | 2.28E−02 | 5.32E−02 | 6.81E−02 | 4.54E−02 | 1.28E−01 | 3.64E−02 | 3.48E−02 |
| C | −3.83E−02 | −3.64E−02 | −8.17E−02 | −1.18E−01 | −1.21E−01 | −4.09E−01 | −1.27E−01 | −9.07E−02 |
| D | 3.37E−02 | 3.65E−02 | 9.04E−02 | 1.29E−01 | 1.91E−01 | 7.63E−01 | 2.17E−01 | 1.29E−01 |
| E | −1.88E−02 | −2.36E−02 | −6.65E−02 | −7.85E−02 | −1.85E−01 | −8.86E−01 | −2.42E−01 | −1.25E−01 |
| F | 6.48E−03 | 9.86E−03 | 3.18E−02 | 2.04E−02 | 1.14E−01 | 6.50E−01 | 1.76E−01 | 7.80E−02 |
| G | −1.34E−03 | −2.60E−03 | −9.60E−03 | 3.03E−03 | −4.28E−02 | −2.92E−01 | −7.86E−02 | −2.99E−02 |
| H | 1.45E−04 | 3.95E−04 | 1.65E−03 | −2.97E−03 | 9.07E−03 | 7.33E−02 | 1.97E−02 | 6.36E−03 |
| J | −5.92E−06 | −2.65E−05 | −1.22E−04 | 4.78E−04 | −8.45E−04 | −7.89E−03 | −2.12E−03 | −5.71E−04 |
| Surface | 10 | 11 | 12 | 13 | 14 | 15 | 16 | 17 |
| K | −9.00E+01 | −8.14E+01 | −8.81E+01 | −8.49E+01 | −1.32E+01 | −6.27E+01 | 9.00E+01 | −1.51E+01 |
| A | −3.79E−02 | −4.06E−02 | −3.09E−02 | −6.32E−02 | 1.07E−02 | 5.02E−02 | −1.26E−01 | −6.29E−02 |
| B | −3.19E−02 | 2.09E−02 | 3.34E−02 | 1.16E−02 | −2.77E−02 | −4.22E−02 | 4.13E−02 | 1.49E−02 |
| C | 1.10E−01 | −3.43E−02 | −2.98E−04 | −5.39E−03 | 1.62E−03 | 1.03E−02 | −7.92E−03 | −2.10E−03 |
| D | −1.82E−01 | 3.30E−02 | −2.59E−03 | 2.17E−03 | 2.28E−03 | −8.50E−04 | 1.02E−03 | 2.18E−04 |
| E | 1.70E−01 | −2.11E−02 | 1.39E−03 | −8.13E−04 | −8.23E−04 | −1.66E−04 | −8.76E−05 | −1.86E−05 |
| F | −9.60E−02 | 8.51E−03 | −2.28E−04 | 2.41E−04 | 1.43E−04 | 5.15E−05 | 4.99E−06 | 1.22E−06 |
| G | 3.22E−02 | −2.13E−03 | −3.23E−05 | −4.17E−05 | −1.39E−05 | −5.62E−06 | −1.80E−07 | −5.36E−08 |
| H | −5.93E−03 | 3.07E−04 | 1.40E−05 | 3.61E−06 | 7.28E−07 | 2.88E−07 | 3.73E−09 | 1.36E−09 |
| J | 4.59E−04 | −1.94E−05 | −1.14E−06 | −1.22E−07 | −1.58E−08 | −5.82E−09 | −3.39E−11 | −1.51E−11 |

### Sixth Embodiment

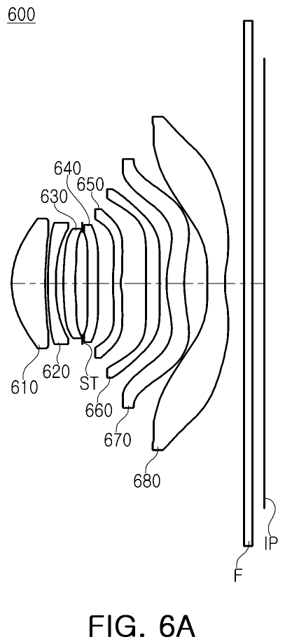

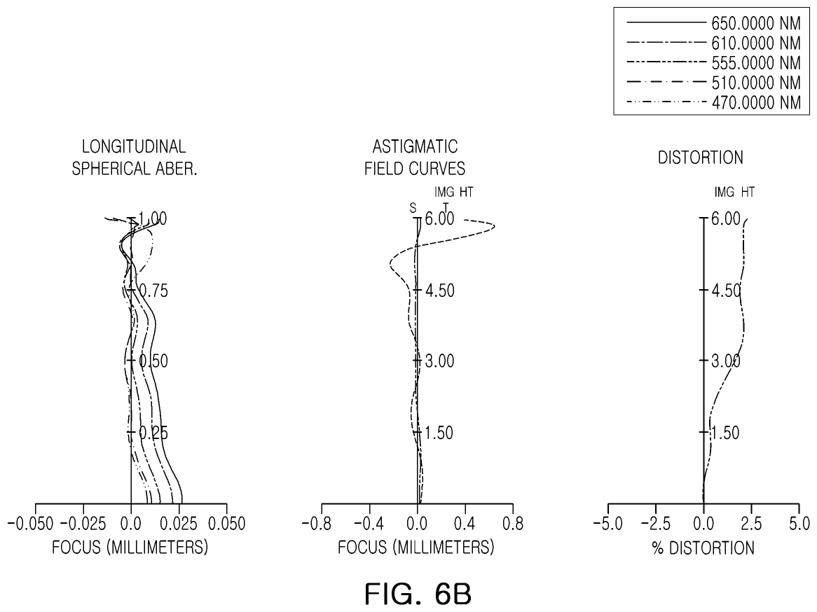

FIG. 6A is a configuration diagram of an optical imaging system according to a sixth embodiment of the present disclosure. FIG. 6B are graphs illustrating the aberration characteristics of the optical imaging system according to the sixth embodiment of the present disclosure.

According to the sixth embodiment, an optical imaging system 600 may include a first lens 610, a second lens 620, a third lens 630, a fourth lens 640, a fifth lens 650, a sixth lens 660, a seventh lens 670, and an eighth lens 680, sequentially arranged from an object side, and may further include an infrared cut-off filter F and an image sensor (an imaging plane (IP)), arranged on an image side of the eighth lens 680. Additionally, the optical imaging system 600 may further include a stop ST disposed between the third lens 630 and the fourth lens 640.

The first lens 610 may have a positive refractive power. An object-side surface of the first lens 610 may be convex in a paraxial region, and an image-side surface of the first lens 610 may be concave in the paraxial region. The first lens 610 may be formed of a plastic material. Additionally, the first lens 610 may be an aspherical lens. For example, the first lens 610 may be a double-sided aspherical lens in which both the object-side surface and the image-side surface are aspherical.

The second lens 620 may have a negative refractive power. An object-side surface of the second lens 620 may be convex in a paraxial region, and an image-side surface of the second lens 620 may be concave in the paraxial region. The second lens 620 may be formed of a plastic material. For example, the second lens 620 may be formed of a plastic material having different optical properties (e.g., a different refractive index and Abbe number) than the first lens 610, and in an example, an Abbe number of the second lens 620 may be less than 20. Additionally, the second lens 620 may be an aspherical lens. For example, the second lens 620 may be a double-sided aspherical lens in which both the object-side surface and the image-side surface are aspherical.

The third lens 630 may have a positive refractive power. An object-side surface of the third lens 630 may be convex in a paraxial region, and an image-side surface of the third lens 630 may be concave in the paraxial region. The third lens 630 may be formed of a plastic material. For example, the third lens 630 may be formed of a plastic material having different optical properties (e.g., a different refractive index and Abbe number) than the second lens 620. Additionally, the third lens 630 may be an aspherical lens. For example, the third lens 630 may be a double-sided aspherical lens in which both the object-side surface and the image-side surface are aspherical.

The fourth lens 640 may have a positive refractive power. Both an object-side surface and an image-side surface of the fourth lens 640 may be convex in a paraxial region. The fourth lens 640 may be formed of a plastic material. For example, the fourth lens, 640, may be formed of a plastic material with different optical properties (e.g., a different refractive index and Abbe number) than the third lens, 630. Additionally, the fourth lens 640 may be an aspherical lens. For example, the fourth lens 640 may be a double-sided aspherical lens in which both the object-side surface and the image-side surface are aspherical.

The fifth lens 650 may have a negative refractive power. An object-side surface of the fifth lens 650 may be convex in a paraxial region, and an image-side surface of the fifth lens 650 may be concave in the paraxial region. The fifth lens 650 may be formed of a plastic material. For example, the fifth lens 650 may be formed of a plastic material having different optical properties (e.g., a different refractive index and Abbe number) than the fourth lens 640, and in an example, an Abbe number of the fifth lens 650 may be less than 20. Additionally, the fifth lens 650 may be an aspherical lens. For example, the fifth lens 650 may be a double-sided aspherical lens in which both the object-side surface and the image-side surface are aspherical.

The sixth lens 660 may have a negative refractive power. An object-side surface of the sixth lens 660 may be convex in a paraxial region, and an image-side surface of the sixth lens 660 may be concave in the paraxial region. The sixth lens 660 may be formed of a plastic material. For example, the sixth lens 660 may be formed of a plastic material having different optical properties (e.g., a different refractive index and Abbe number) than the fifth lens 650. Additionally, the sixth lens 660 may be an aspherical lens. For example, the sixth lens 660 may be a double-sided aspherical lens in which both the object-side surface and the image-side surface are aspherical.

The seventh lens 670 may have a positive refractive power. An object-side surface of the seventh lens 670 may be convex in a paraxial region, and an image-side surface of the seventh lens 670 may be concave in the paraxial region. The seventh lens 670 may be formed of a plastic material. For example, the seventh lens 670 may be formed of a plastic material having different optical properties (e.g., a different refractive index and Abbe number) than the sixth lens 660. Additionally, the seventh lens 670 may be an aspherical lens. For example, the seventh lens 670 may be a double-sided aspherical lens in which both the object-side surface and the image-side surface are aspherical.

The eighth lens 680 may have a negative refractive power. Both an object-side surface and an image-side surface of the eighth lens 680 may be concave in a paraxial region. The eighth lens 680 may be formed of a plastic material. For example, the eighth lens 680 may be formed of a plastic material having different optical properties (e.g., a different refractive index and Abbe number) than the seventh lens 670. Additionally, the eighth lens 680 may be an aspherical lens. For example, the eighth lens 680 may be a double-sided aspherical lens in which both the object-side surface and the image-side surface are aspherical.

Table 11 below illustrates optical and physical parameters of the optical imaging system 600 according to the sixth embodiment of the present disclosure.

TABLE 11

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.240 | 0.906 | 1.546 | 55.990 | 1.721 |
| 2 | 11.424 | 0.050 | | | 1.670 |
| 3 | 10.093 | 0.220 | 1.677 | 19.238 | 1.609 |
| 4 | 4.037 | 0.200 | | | 1.471 |
| 5 | 6.430 | 0.322 | 1.570 | 37.403 | 1.449 |
| 6 | 9.832 | 0.182 | | | 1.369 |
| STOP | Infinity | 0.136 | | | 1.343 |
| 7 | 44.053 | 0.286 | 1.546 | 55.990 | 1.402 |
| 8 | −583.655 | 0.394 | | | 1.569 |
| 9 | 5.862 | 0.220 | 1.677 | 19.238 | 1.706 |
| 10 | 5.165 | 0.643 | | | 1.980 |
| 11 | 8.928 | 0.380 | 1.570 | 37.403 | 2.277 |
| 12 | 7.222 | 0.196 | | | 2.510 |
| 13 | 3.005 | 0.480 | 1.546 | 55.990 | 3.013 |
| 14 | 6.664 | 0.593 | | | 3.243 |
| 15 | −114.119 | 0.480 | 1.537 | 55.735 | 4.209 |
| 16 | 2.803 | 0.500 | | | 4.413 |
| 17 | Infinity | 0.210 | 1.518 | 64.197 | |
| 18 | Infinity | 0.324 | | | |
| Image | Infinity | | | | |

Table 12 below illustrates aspheric data of the optical imaging system 600 according to the sixth embodiment of the present disclosure.

TABLE 12

| Surface | 1 | 2 | 3 | 4 | 5 | 6 | 8 | 9 |
|---|---|---|---|---|---|---|---|---|
| K | −9.14E−01 | −8.99E+01 | 2.68E+01 | 2.91E+00 | 1.70E+01 | 4.64E+01 | 9.00E+01 | 9.00E+01 |
| A | −1.27E−04 | −7.20E−03 | −2.18E−02 | −3.30E−02 | −3.70E−02 | −3.56E−02 | −3.99E−02 | −4.29E−02 |
| B | 2.43E−02 | 2.23E−02 | 5.13E−02 | 1.15E−01 | 6.95E−02 | 1.08E−01 | 7.11E−02 | 5.99E−02 |
| C | −3.87E−02 | −3.29E−02 | −7.27E−02 | −2.59E−01 | −1.90E−01 | −3.71E−01 | −2.05E−01 | −1.34E−01 |
| D | 3.78E−02 | 2.93E−02 | 7.39E−02 | 3.73E−01 | 3.20E−01 | 7.57E−01 | 3.48E−01 | 1.87E−01 |
| E | −2.36E−02 | −1.79E−02 | −5.29E−02 | −3.37E−01 | −3.28E−01 | −9.52E−01 | −3.92E−01 | −1.78E−01 |
| F | 9.29E−03 | 7.45E−03 | 2.62E−02 | 1.88E−01 | 2.11E−01 | 7.52E−01 | 2.88E−01 | 1.11E−01 |
| G | −2.22E−03 | −2.08E−03 | −8.50E−03 | −6.08E−02 | −8.16E−02 | −3.63E−01 | −1.32E−01 | 9.52E−03 |
| H | 2.90E−04 | 3.48E−04 | 1.61E−03 | 9.98E−03 | 1.73E−02 | 9.74E−02 | 3.42E−02 | 9.52E−03 |
| J | −1.54E−05 | −2.62E−05 | −1.33E−04 | −5.85E−04 | −1.58E−03 | −1.12E−02 | −3.81E−03 | −8.89E−04 |

| Surface | 10 | 11 | 12 | 13 | 14 | 15 | 16 | 17 |
|---|---|---|---|---|---|---|---|---|
| K | −9.00E+01 | −8.29E+01 | −9.00E+01 | −9.00E+01 | −1.59E+01 | −7.29E+01 | 9.40E+00 | −1.70E+01 |
| A | 3.27E−02 | −3.58E−02 | −4.32E−02 | −8.23E−02 | 1.03E−02 | 5.03E−02 | −1.27E−01 | −5.93E−02 |
| B | −4.79E−02 | 8.55E−03 | 1.26E−02 | 2.66E−02 | −2.92E−02 | −4.20E−02 | 4.32E−02 | 1.25E−02 |
| C | 1.34E−01 | −2.29E−02 | −3.27E−03 | −1.20E−02 | 2.02E−103 | 9.34E−03 | −8.56E−03 | −1.06E−03 |
| D | −2.18E−01 | 2.56E−02 | −3.94E−03 | 3.18E−03 | 2.31E−03 | −3.20E−04 | 1.11E−03 | −1.68E−05 |
| E | 2.07E−01 | −1.77E−02 | 2.95E−03 | −4.11E−04 | −8.66E−04 | −3.18E−04 | −9.58E−05 | 1.20E−05 |
| F | −1.21E−01 | 7.51E−03 | −8.16E−04 | −2.73E−06 | 1.54E−04 | 7.69E−05 | 5.39E−06 | −1.18−E06 |
| G | 4.20E−02 | −1.98E−03 | 7.36E−05 | 1.26E−05 | −1.53E−05 | −8.07−06 | −1.90E−07 | 5.85E−08 |
| H | −7.99E−03 | 3.04E−04 | 5.80E−06 | −2.17E−06 | 8.17E−07 | 4.14E−07 | 3.80E−09 | −1.50E−09 |
| J | 6.42E−04 | −2.07E−05 | −9.86E−07 | 1.22E−07 | −1.82E−08 | −8.50E−09 | −3.29E−11 | 1.57E−11 |

### Seventh Embodiment

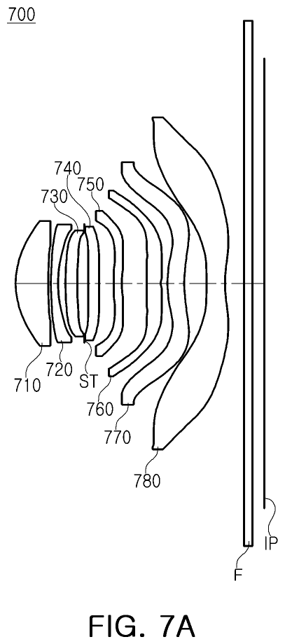

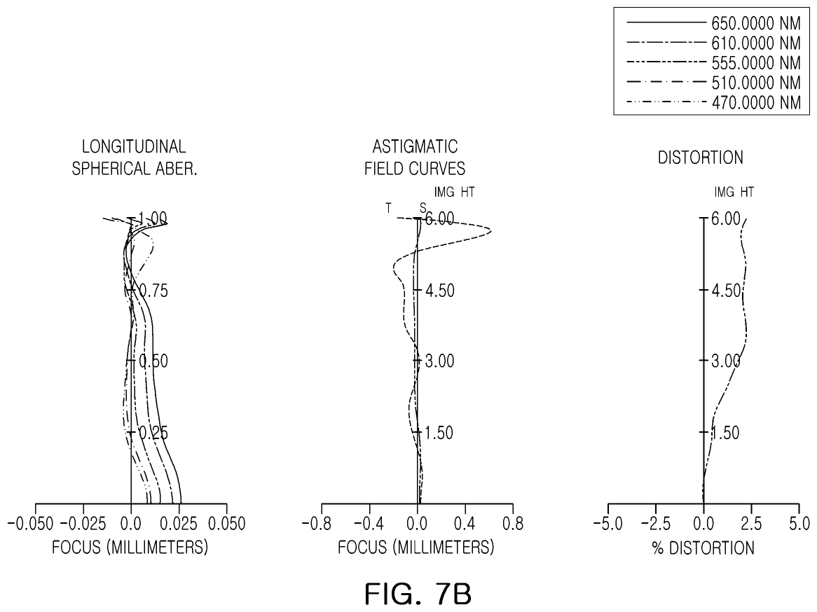

FIG. 7A is a configuration diagram of an optical imaging system according to a seventh embodiment of the present disclosure. FIG. 7B are graphs illustrating the aberration characteristics of the optical imaging system according to the seventh embodiment of the present disclosure.

According to the seventh embodiment, an optical imaging system 700 may include a first lens 710, a second lens 720, a third lens 730, a fourth lens 740, a fifth lens 750, a sixth lens 760, a seventh lens 770, and an eighth lens 780, sequentially arranged from an object side, and may further include an infrared cut-off filter F and an image sensor (an imaging plane (IP)), arranged on an image side of the eighth lens 780. Additionally, the optical imaging system 700 may further include a stop ST disposed between the third lens 730 and the fourth lens 740.

The first lens 710 may have a positive refractive power. An object-side surface of the first lens 710 may be convex in a paraxial region, and an image-side surface of the first lens 710 may be concave in the paraxial region. The first lens 710 may be formed of a plastic material. Additionally, the first lens 710 may be an aspherical lens. For example, the first lens 710 may be a double-sided aspherical lens in which both the object-side surface and the image-side surface are aspherical.

The second lens 720 may have a negative refractive power. An object-side surface of the second lens 720 may be convex in a paraxial region, and an image-side surface of the second lens 720 may be concave in the paraxial region. The second lens 720 may be formed of a plastic material. For example, the second lens 720 may be formed of a plastic material having different optical properties (e.g., a different refractive index and Abbe number) than the first lens 710, and in an example, an Abbe number of the second lens 720 may be less than 20. Additionally, the second lens 720 may be an aspherical lens. For example, the second lens 720 may be a double-sided aspherical lens in which both the object-side surface and the image-side surface are aspherical.

The third lens 730 may have a positive refractive power. An object-side surface of the third lens 730 may be convex in a paraxial region, and an image-side surface of the third lens 730 may be concave in the paraxial region. The third lens 730 may be formed of a plastic material. For example, the third lens 730 may be formed of a plastic material having different optical properties (e.g., a different refractive index and Abbe number) than the second lens 720. Additionally, the third lens 730 may be an aspherical lens. For example, the third lens 730 may be a double-sided aspherical lens in which both the object-side surface and the image-side surface are aspherical.

The fourth lens 740 may have a positive refractive power. An object-side surface of the fourth lens 740 may be convex in a paraxial region, and an image-side surface of the fourth lens 740 may be concave in the paraxial region. The fourth lens 740 may be formed of a plastic material. For example, the fourth lens 740 may be formed of a plastic material having different optical properties (e.g., a different refractive index and Abbe number) than the third lens 730. Additionally, the fourth lens 740 may be an aspherical lens. For example, the fourth lens 740 may be a double-sided aspherical lens in which both the object-side surface and the image-side surface are aspherical.

The fifth lens 750 may have a negative refractive power. An object-side surface of the fifth lens 750 may be convex in a paraxial region, and an image-side surface of the fifth lens 750 may be concave in the paraxial region. The fifth lens 750 may be formed of a plastic material. For example, the fifth lens 750 may be formed of a plastic material having different optical properties (e.g., a different refractive index and Abbe number) than the fourth lens 740, and in an example, an Abbe number of the fifth lens 750 may be less than 20. Additionally, the fifth lens 750 may be an aspherical lens. For example, the fifth lens 750 may be a double-sided aspherical lens in which both the object-side surface and the image-side surface are aspherical.

The sixth lens 760 may have a negative refractive power. An object-side surface of the sixth lens 760 may be convex in a paraxial region, and an image-side surface of the sixth lens 760 may be concave in the paraxial region. The sixth lens 760 may be formed of a plastic material. For example, the sixth lens 760 may be formed of a plastic material having different optical properties (e.g., a different refractive index and Abbe number) than the fifth lens 750. Additionally, the sixth lens 760 may be an aspherical lens. For example, the sixth lens 760 may be a double-sided aspherical lens in which both the object-side surface and the image-side surface are aspherical.

The seventh lens 770 may have a positive refractive power. An object-side surface of the seventh lens 770 may be convex in a paraxial region, and an image-side surface of the seventh lens 770 may be concave in the paraxial region. The seventh lens 770 may be formed of a plastic material. For example, the seventh lens, 770, may be formed of a plastic material with different optical properties (e.g., a different refractive index and Abbe number) than the sixth lens, 760. Additionally, the seventh lens 770 may be an aspherical lens. For example, the seventh lens 770 may be a double-sided aspherical lens in which both the object-side surface and the image-side surface are aspherical.

The eighth lens 780 may have a negative refractive power. An object-side surface of the eighth lens 780 may be convex in a paraxial region, and an image-side surface of the eighth lens 780 may be concave in the paraxial region. The eighth lens 780 may be formed of a plastic material. For example, the eighth lens 780 may be formed of a plastic material having different optical properties (e.g., a different refractive index and Abbe number) than the seventh lens 770. Additionally, the eighth lens 780 may be an aspherical lens. For example, the eighth lens 780 may be a double-sided aspherical lens in which both the object-side surface and the image-side surface are aspherical.

Table 13 below illustrates optical and physical parameters of the optical imaging system 700 according to the seventh embodiment of the present disclosure.

TABLE 13

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.184 | 0.870 | 1.546 | 55.990 | 1.663 |
| 2 | 10.641 | 0.050 | | | 1.617 |
| 3 | 9.470 | 0.220 | 1.677 | 19.238 | 1.556 |
| 4 | 3.897 | 0.172 | | | 1.421 |
| 5 | 6.096 | 0.317 | 1.570 | 37.403 | 1.402 |
| 6 | 9.234 | 0.189 | | | 1.312 |
| STOP | Infinity | 0.115 | | | 1.299 |
| 7 | 34.841 | 0.271 | 1.546 | 55.990 | 1.350 |
| 8 | 133.018 | 0.405 | | | 1.505 |
| 9 | 5.842 | 0.220 | 1.677 | 19.238 | 1.652 |
| 10 | 5.318 | 0.657 | | | 1.928 |
| 11 | 9.166 | 0.386 | 1.570 | 37.403 | 2.278 |
| 12 | 5.269 | 0.168 | | | 2.461 |
| 13 | 2.595 | 0.480 | 1.546 | 55.990 | 2.948 |
| 14 | 6.698 | 0.552 | | | 3.217 |
| 15 | 145.384 | 0.489 | 1.537 | 55.735 | 4.196 |
| 16 | 2.665 | 0.500 | | | 4.395 |
| 17 | Infinity | 0.210 | 1.518 | 64.197 | |
| 18 | Infinity | 0.327 | | | |
| Image | Infinity | | | | |

Table 14 below illustrates aspheric data of the optical imaging system 700 according to the seventh embodiment of the present disclosure.

TABLE 14

| Surface | 1 | 2 | 3 | 4 | 5 | 6 | 8 | 9 |
|---|---|---|---|---|---|---|---|---|
| K | −9.99E−01 | −9.00E+01 | 2.68E+01 | 3.01E+00 | 1.65E+01 | 4.39E+01 | 9.00E+01 | 9.00E+01 |
| A | 1.01E−03 | 7.81E−03 | −4.29E−03 | −2.66E−02 | −3.12E−02 | −3.17E−02 | −4.80E−02 | −4.69E−02 |
| B | 3.04E−02 | −3.12E−02 | 1.80E−02 | 9.10E−02 | 5.35E−02 | 1.02E−01 | 8.30E−02 | 4.77E−02 |
| C | −5.73E−02 | 6.00E−02 | 5.55E−02 | −2.41E−01 | −1.87E−01 | −3.81E−01 | −2.32E−01 | −9.05E−02 |
| D | 6.46E−02 | −6.90E−02 | −6.41E−02 | 4.17E−01 | 3.98E−01 | 8.58E−01 | 4.18E−01 | 1.19E−01 |
| E | −4.61E−02 | 4.80E−02 | 3.84E−02 | −4.44E−01 | −4.95E−01 | −1.18E+00 | −5.09E−01 | −1.18E−01 |
| F | 2.07E−02 | −2.09E−02 | −1.10E−02 | 2.87E−01 | 3.75E−01 | 1.02E+00 | 4.09E−01 | 8.21E−02 |
| G | −5.73E−03 | 5.55E−03 | 3.57E−04 | −1.07E−01 | −1.68E−01 | −5.32E−01 | −2.06E−01 | −3.65E−02 |
| H | 8.79E−04 | −8.14E−04 | 5.28E−04 | 2.05E−02 | 4.09E−02 | 1.55E−01 | 5.84E−02 | 9.22E−03 |
| J | −5.68E−05 | 5.03E−05 | −8.67E−05 | −1.47E−03 | −4.24E−03 | −1.93E−02 | −7.15E−03 | −9.93E−04 |
| Surface | 10 | 11 | 12 | 13 | 14 | 15 | 16 | 17 |
| K | −9.00E+01 | −7.76E+01 | −8.96E+01 | −9.00E+01 | −1.67E+01 | −9.00E+01 | −9.27E+00 | −1.54E+01 |
| A | −3.22E−02 | −4.11E−02 | −5.77E−02 | −9.72E−02 | 8.98E−03 | 5.07E−02 | −1.43E−01 | −6.92E−02 |
| B | −6.16E−02 | 1.14E−02 | 4.19E−02 | 4.93E−02 | −3.05E−02 | −4.52E−02 | 5.51E−02 | 2.05E−02 |
| C | 1.61E−01 | −2.67E−02 | −3.33E−02 | −3.29E−02 | 2.36E−03 | 1.16E−02 | −1.25E−02 | −3.83E−03 |
| D | −2.65E−01 | 2.76E−02 | 1.42E−02 | 1.49E−02 | 2.36E−03 | −1.07E−03 | 1.84E−03 | 5.10E−04 |
| E | 2.61E−01 | −1.82E−02 | −3.62E−03 | −4.34E−03 | −9.06E−04 | 1.69E−04 | −1.78E−04 | −4.93E−05 |
| F | −1.59E−01 | 7.65E−03 | 5.35E−04 | 7.49E−04 | 1.64E−04 | 5.84E−05 | 1.12E−05 | 3.25E−06 |
| G | 5.82E−02 | −2.06E−03 | −6.19E−05 | −6.07E−05 | −1.67E−05 | −6.63E−06 | −4.38E−07 | −1.36E−07 |
| H | −1.18E−02 | 3.37E−04 | 8.95E−06 | 2.16E−07 | 9.09E−07 | 3.51E−07 | 9.78E−09 | 3.21E−09 |
| J | 1.01E−03 | −2.48E−05 | −7.18E−07 | 1.79E−07 | −2.07E−08 | −7.32E−09 | −9.46E−11 | 3.27E−11 |

### Eighth Embodiment

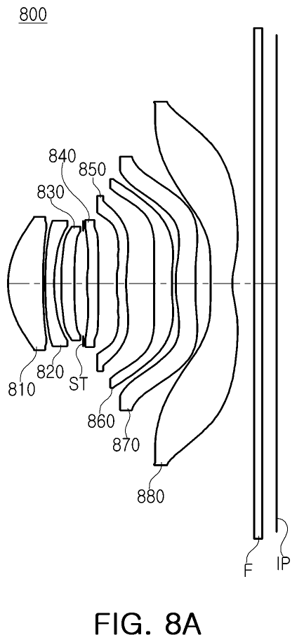

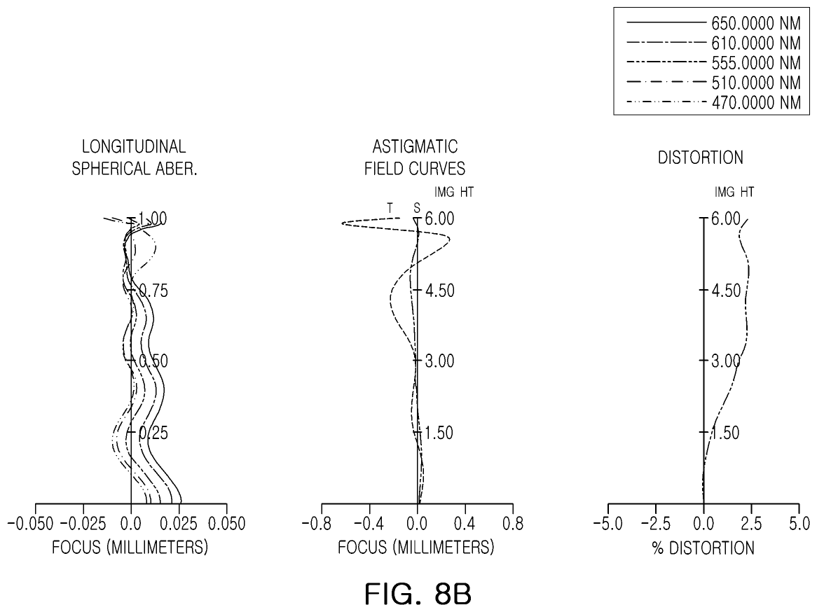

FIG. 8A is a configuration diagram of an optical imaging system according to an eighth embodiment of the present disclosure. FIG. 8B are graphs illustrating the aberration characteristics of the optical imaging system according to the eighth embodiment of the present disclosure.

According to the eighth embodiment, an optical imaging system 800 may include a first lens 810, a second lens 820, a third lens 830, a fourth lens 840, a fifth lens 850, a sixth lens 860, a seventh lens 870, and an eighth lens 880, sequentially arranged from an object side, and may further include an infrared cut-off filter F and an image sensor (an imaging plane (IP)), arranged on an image side of the eighth lens 880. Additionally, the optical imaging system 800 may further include a stop ST disposed between the third lens 830 and the fourth lens 840.

The first lens 810 may have a positive refractive power. An object-side surface of the first lens 810 may be convex in a paraxial region, and an image-side surface of the first lens 810 may be concave in the paraxial region. The first lens 810 may be formed of a plastic material. Additionally, the first lens 810 may be an aspherical lens. For example, the first lens 810 may be a double-sided aspherical lens in which both the object-side surface and the image-side surface are aspherical.

The eighth lens 820 may have a negative refractive power. An object-side surface of the second lens 820 may be convex in a paraxial region, and an image-side surface of the second lens 820 may be concave in the paraxial region. The second lens 820 may be formed of a plastic material. For example, the second lens 820 may be formed of a plastic material having different optical properties (e.g., a different refractive index and Abbe number) than the first lens 810, and in an example, an Abbe number of the second lens 820 may be less than 20. Additionally, the second lens 820 may be an aspherical lens. For example, the second lens 820 may be a double-sided aspherical lens in which both the object-side surface and the image-side surface are aspherical.

The third lens 830 may have a positive refractive power. An object-side surface of the third lens 830 may be convex in a paraxial region, and an image-side surface of the third lens 830 may be concave in the paraxial region. The third lens 830 may be formed of a plastic material. For example, the third lens 830 may be formed of a plastic material having different optical properties (e.g., a different refractive index and Abbe number) than the second lens 820. Additionally, the third lens 830 may be an aspherical lens. For example, the third lens 830 may be a double-sided aspherical lens in which both the object-side surface and the image-side surface are aspherical.

The fourth lens 840 may have a positive refractive power. An object-side surface of the fourth lens 840 may be convex in a paraxial region, and an image-side surface of the fourth lens 840 may be concave in the paraxial region. The fourth lens 840 may be formed of a plastic material. For example, the fourth lens 840 may be formed of a plastic material having different optical properties (e.g., a different refractive index and Abbe number) than the third lens 830. Additionally, the fourth lens 840 may be an aspherical lens. For example, the fourth lens 840 may be a double-sided aspherical lens in which both the object-side surface and the image-side surface are aspherical.

The fifth lens 850 may have a negative refractive power. An object-side surface of the fifth lens 850 may be convex in a paraxial region, and an image-side surface of the fifth lens 850 may be concave in the paraxial region. The fifth lens 850 may be formed of a plastic material. For example, the fifth lens 850 may be formed of a plastic material having different optical properties (e.g., a different refractive index and Abbe number) than the fourth lens 840, and in an example, an Abbe number of the fifth lens 850 may be less than 20. Additionally, the fifth lens 850 may be an aspherical lens. For example, the fifth lens 850 may be a double-sided aspherical lens in which both the object-side surface and the image-side surface are aspherical.

The sixth lens 860 may have a negative refractive power. An object-side surface of the sixth lens 860 may be convex in a paraxial region, and an image-side surface of the sixth lens 860 may be concave in the paraxial region. The sixth lens 860 may be formed of a plastic material. For example, the sixth lens 860 may be formed of a plastic material having different optical properties (e.g., a different refractive index and Abbe number) than the fifth lens 850. Additionally, the sixth lens 860 may be an aspherical lens. For example, the sixth lens 860 may be a double-sided aspherical lens in which both the object-side surface and the image-side surface are aspherical.

The seventh lens 870 may have a positive refractive power. An object-side surface of the seventh lens 870 may be convex in a paraxial region, and an image-side surface of the seventh lens 870 may be concave in the paraxial region. The seventh lens 870 may be formed of a plastic material. For example, the seventh lens 870 may be formed of a plastic material having different optical properties (e.g., a different refractive index and Abbe number) than the sixth lens 860. Additionally, the seventh lens 870 may be an aspherical lens. For example, the seventh lens 870 may be a double-sided aspherical lens in which both the object-side surface and the image-side surface are aspherical.

The eighth lens 880 may have a negative refractive power. An object-side surface of the eighth lens 880 may be convex in a paraxial region, and an image-side surface of the eighth lens 880 may be concave in the paraxial region. The eighth lens 880 may be formed of a plastic material. For example, the eighth lens 880 may be formed of a plastic material having different optical properties (e.g., a different refractive index and Abbe number) than the seventh lens 870. Additionally, the eighth lens 880 may be an aspherical lens. For example, the eighth lens 880 may be a double-sided aspherical lens in which both the object-side surface and the image-side surface are aspherical.

Table 15 below illustrates optical and physical parameters of the optical imaging system 800 according to the eighth embodiment of the present disclosure.

TABLE 15

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.119 | 0.839 | 1.546 | 55.990 | 1.607 |
| 2 | 9.782 | 0.050 | | | 1.560 |
| 3 | 9.138 | 0.220 | 1.677 | 19.238 | 1.505 |
| 4 | 3.773 | 0.165 | | | 1.378 |
| 5 | 5.838 | 0.317 | 1.570 | 37.403 | 1.358 |
| 6 | 8.956 | 0.206 | | | 1.276 |
| STOP | Infinity | 0.112 | | | 1.248 |
| 7 | 18.244 | 0.267 | 1.546 | 55.990 | 1.372 |
| 8 | 46.277 | 0.448 | | | 1.543 |
| 9 | 4.707 | 0.220 | 1.677 | 19.238 | 1.703 |
| 10 | 4.338 | 0.665 | | | 1.977 |
| 11 | 8.542 | 0.434 | 1.570 | 37.403 | 2.321 |
| 12 | 4.733 | 0.102 | | | 2.500 |
| 13 | 3.386 | 0.480 | 1.546 | 55.990 | 2.777 |
| 14 | 24.684 | 0.369 | | | 3.075 |
| 15 | 51.813 | 0.529 | 1.537 | 55.735 | 4.146 |
| 16 | 2.508 | 0.500 | | | 4.359 |
| 17 | Infinity | 0.210 | 1.518 | 64.197 | |
| 18 | Infinity | 0.347 | | | |
| Image | Infinity | | | | |

Table 16 below illustrates aspheric data of the optical imaging system 800 according to the eighth embodiment of the present disclosure.

TABLE 16

| Surface | 1 | 2 | 3 | 4 | 5 | 6 | 8 | 9 |
|---|---|---|---|---|---|---|---|---|
| K | −1.04E+00 | −9.00E+01 | 2.63E+01 | 2.88E+00 | 1.59E+01 | 4.39E+01 | 9.00E+01 | 8.42E+01 |
| A | −1.03E−04 | 6.29E−03 | −7.72E−03 | −2.83E−02 | −3.00E−02 | −5.34E−02 | −4.56E−02 | −3.72E−02 |
| B | 4.40E−02 | −2.72E−02 | −2.50E−02 | 7.55E−02 | 2.32E−02 | 2.43E−01 | 1.54E−02 | −2.35E−02 |
| C | −9.22E−02 | 6.70E−02 | 1.07E−01 | −1.90E−01 | −1.13E−01 | −9.22E−01 | 6.14E−02 | 1.33E−01 |
| D | 1.13E−01 | −9.11E−02 | −1.59E−01 | 3.63E−01 | 3.12E−01 | 2.09E+00 | −2.75E−01 | −2.83E−01 |
| E | −8.65E−02 | 7.12E−02 | 1.29E−01 | −4.37E−01 | −4.48E−01 | −2.92E+00 | 4.68E−01 | 3.26E−01 |
| F | 4.14E−02 | −3.39E−02 | −6.06E−02 | 3.17E−01 | 3.77E−01 | 2.56E+00 | −4.35E−01 | −2.24E−01 |
| G | −1.21E−02 | 9.67E−03 | 1.61E−02 | −1.31E−01 | −1.82E−01 | −1.37E+00 | 2.32E−01 | 9.15E−02 |
| H | 1.96E−03 | −1.51E−03 | −2.12E−03 | 2.76E−02 | 4.76E−02 | 4.09E−01 | −6.62E−02 | −2.03E−02 |
| J | −1.35E−04 | 9.91E−05 | 9.31E−05 | −2.18E−03 | −5.26E−03 | −5.25E−02 | 7.80E−03 | 1.88E−03 |
| Surface | 10 | 11 | 12 | 13 | 14 | 15 | 16 | 17 |
| K | −7.94E+01 | −7.40E+01 | −9.00E+01 | −9.00E+01 | −3.28E+01 | −1.38E+01 | −7.22E+01 | −1.31E+01 |
| A | 2.16E+02 | −1.08E−02 | −6.15E−02 | −9.53E−02 | 7.29E−03 | 6.41E−02 | −1.18E−01 | −6.67E−02 |
| B | −3.80E−02 | −5.64E−02 | 4.74E−02 | 4.81E−02 | −3.72E−02 | −7.04E−02 | 4.09E−02 | 2.20E−02 |
| C | 2.94E−02 | 7.12E−02 | −3.14E−02 | −2.69E−02 | 2.62E−03 | 2.48E−02 | −9.07E−03 | −4.69E−03 |
| D | −9.11E−04 | −6.07E−02 | 5.80E−03 | 5.71E−03 | 3.64E−03 | −4.75E−03 | 1.39E−03 | 7.01E−04 |
| E | −2.51E−02 | 3.25E−02 | 3.08E−03 | 1.07E−03 | −1.48E−03 | 3.93E−04 | −1.42E−04 | −7.38E−05 |
| F | 2.30E−02 | −1.10E−02 | −2.13E−03 | −8.87E−04 | 2.92E−04 | 1.63E−02 | 9.41E−06 | 5.20E−06 |
| G | −9.58E−03 | 2.23E−03 | 5.26E−04 | 2.11E−04 | −3.29E−05 | −5.92E−06 | −3.88E−07 | −2.30E−07 |
| H | 1.92E−03 | −2.36E−04 | −5.98E−05 | −2.33E−05 | 2.02E−06 | 4.37E−07 | 9.05E−09 | 5.71E−09 |
| J | −1.45E−04 | 9.44E−06 | 2.59E−06 | 1.01E−06 | −5.23E−08 | −1.11E−08 | −9.12E−11 | −6.09E−11 |

### Ninth Embodiment

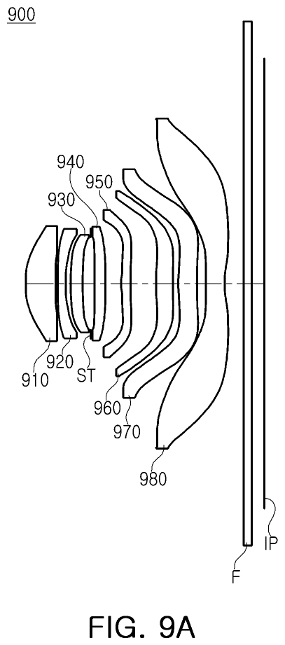

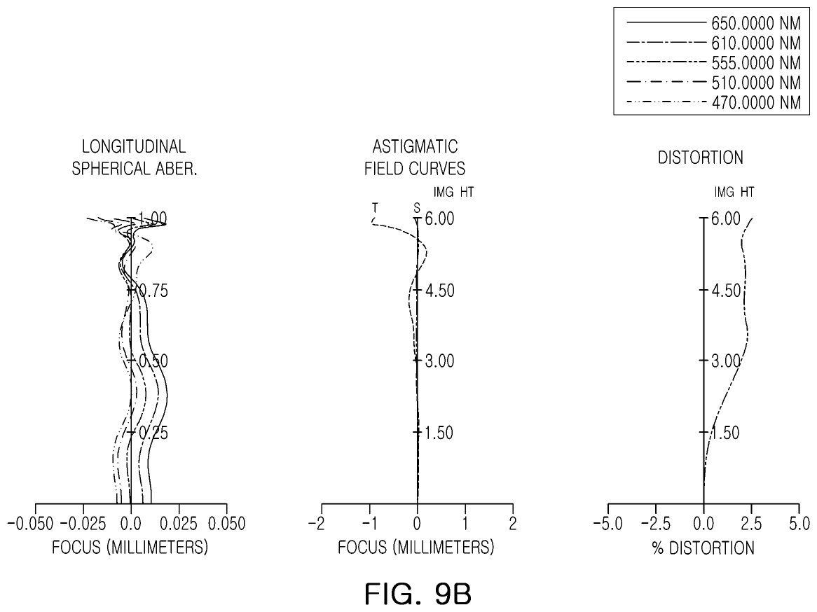

FIG. 9A is a configuration diagram of an optical imaging system according to a ninth embodiment of the present disclosure. FIG. 9B are graphs illustrating the aberration characteristics of the optical imaging system according to the ninth embodiment of the present disclosure.

According to the ninth embodiment, an optical imaging system 900 may include a first lens 910, a second lens 920, a third lens 930, a fourth lens 940, a fifth lens 950, a sixth lens 960, a seventh lens 970, and an eighth lens 980, sequentially arranged from an object side, and may further include an infrared cut-off filter F and an image sensor (an imaging plane (IP)), arranged on an image side of the eighth lens 980. Additionally, the optical imaging system 900 may further include a stop ST disposed between the third lens 930 and the fourth lens 940.

The first lens 910 may have a positive refractive power. An object-side surface of the first lens 910 may be convex in a paraxial region, and an image-side surface of the first lens 910 may be concave in the paraxial region. The first lens 910 may be formed of a plastic material. Additionally, the first lens 910 may be an aspherical lens. For example, the first lens 910 may be a double-sided aspherical lens in which both the object-side surface and the image-side surface are aspherical.

The second lens 920 may have a negative refractive power. An object-side surface of the second lens 920 may be convex in a paraxial region, and an image-side surface of the second lens 920 may be concave in the paraxial region. The second lens 920 may be formed of a plastic material. For example, the second lens 920 may be formed of a plastic material having different optical properties (e.g., a different refractive index and Abbe number) than the first lens 910, and in an example, an Abbe number of the second lens 920 may be less than 20. Additionally, the second lens 920 may be an aspherical lens. For example, the second lens 920 may be a double-sided aspherical lens in which both the object-side surface and the image-side surface are aspherical.

The third lens 930 may have a positive refractive power. An object-side surface of the third lens 930 may be convex in a paraxial region, and an image-side surface of the third lens 930 may be concave in the paraxial region. The third lens 930 may be formed of a plastic material. For example, the third lens 930 may be formed of a plastic material having different optical properties (e.g., a different refractive index and Abbe number) than the second lens 920. Additionally, the third lens 930 may be an aspherical lens. For example, the third lens 930 may be a double-sided aspherical lens in which both the object-side surface and the image-side surface are aspherical.

The fourth lens 940 may have a positive refractive power. Both an object-side surface and an image-side surface of the fourth lens 940 may be convex in a paraxial region. The fourth lens 940 may be formed of a plastic material. For example, the fourth lens 940 may be formed of a plastic material having different optical properties (e.g., a different refractive index and Abbe number) than the third lens 930. Additionally, the fourth lens 940 may be an aspherical lens. For example, the fourth lens 940 may be a double-sided aspherical lens in which both the object-side surface and the image-side surface are aspherical.

The fifth lens 950 may have a negative refractive power. An object-side surface of the fifth lens 950 may be convex in a paraxial region, and an image-side surface of the fifth lens 950 may be concave in the paraxial region. The fifth lens 950 may be formed of a plastic material. For example, the fifth lens 950 may be formed of a plastic material having different optical properties (e.g., a different refractive index and Abbe number) than the fourth lens 940, and in an example, an Abbe number of the fifth lens 950 may be less than 20. Additionally, the fifth lens 950 may be an aspherical lens. For example, the fifth lens 950 may be a double-sided aspherical lens in which both the object-side surface and the image-side surface are aspherical.

The sixth lens 960 may have a positive refractive power. An object-side surface of the sixth lens 960 may be convex in a paraxial region, and an image-side surface of the sixth lens 960 may be concave in the paraxial region. The sixth lens 960 may be formed of a plastic material. For example, the sixth lens 960 may be formed of a plastic material having different optical properties (e.g., a different refractive index and Abbe number) than the fifth lens 950. Additionally, the sixth lens 960 may be an aspherical lens. For example, the sixth lens 960 may be a double-sided aspherical lens in which both the object-side surface and the image-side surface are aspherical.

The seventh lens 970 may have a positive refractive power. An object-side surface of the seventh lens 970 may be convex in a paraxial region, and an image-side surface of the seventh lens 970 may be concave in the paraxial region. The seventh lens 970 may be formed of a plastic material. For example, the seventh lens 970 may be formed of a plastic material having different optical properties (e.g., a different refractive index and Abbe number) than the sixth lens 960. Additionally, the seventh lens 970 may be an aspherical lens. For example, the seventh lens 970 may be a double-sided aspherical lens in which both the object-side surface and the image-side surface are aspherical.

The eighth lens 980 may have a negative refractive power. An object-side surface of the eighth lens 980 may be convex in a paraxial region, and an image-side surface of the eighth lens 980 may be concave in the paraxial region. The eighth lens 980 may be formed of a plastic material. For example, the eighth lens 980 may be formed of a plastic material having different optical properties (e.g., a different refractive index and Abbe number) than the seventh lens 970. Additionally, the eighth lens 980 may be an aspherical lens. For example, the eighth lens 980 may be a double-sided aspherical lens in which both the object-side surface and the image-side surface are aspherical.

Table 17 below illustrates optical and physical parameters of the optical imaging system 900 according to the ninth embodiment of the present disclosure.

TABLE 17

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.091 | 0.797 | 1.546 | 55.990 | 1.543 |
| 2 | 10.819 | 0.050 | | | 1.503 |
| 3 | 8.582 | 0.221 | 1.677 | 19.238 | 1.445 |
| 4 | 3.524 | 0.140 | | | 1.321 |
| 5 | 5.274 | 0.318 | 1.570 | 37.403 | 1.304 |
| 6 | 8.301 | 0.204 | | | 1.216 |
| STOP | Infinity | 0.111 | | | 1.201 |
| 7 | 35.795 | 0.278 | 1.546 | 55.990 | 1.309 |
| 8 | −717.738 | 0.443 | | | 1.495 |
| 9 | 4.493 | 0.221 | 1.677 | 19.238 | 1.678 |
| 10 | 4.254 | 0.703 | | | 1.945 |
| 11 | 9.842 | 0.452 | 1.570 | 37.403 | 2.269 |
| 12 | 9.746 | 0.140 | | | 2.449 |
| 13 | 5.371 | 0.481 | 1.546 | 55.990 | 2.736 |
| 14 | 22.690 | 0.256 | | | 3.032 |
| 15 | 22.272 | 0.493 | 1.537 | 55.735 | 4.177 |
| 16 | 2.345 | 0.500 | | | 4.373 |
| 17 | Infinity | 0.210 | 1.518 | 64.197 | |
| 18 | Infinity | 0.342 | | | |
| Image | Infinity | | | | |

Table 18 below illustrates aspheric data of the optical imaging system 900 according to the ninth embodiment of the present disclosure.

TABLE 18

| Surface | 1 | 2 | 3 | 4 | 5 | 6 | 8 | 9 |
|---|---|---|---|---|---|---|---|---|
| K | −1.18E+00 | −8.76E+01 | 2.60E+01 | 2.91E+00 | 1.42E+01 | 4.16E+01 | 8.28E+01 | −8.86E+01 |
| A | 6.88E−03 | 1.03E−02 | −7.10E−03 | −2.82E−02 | −4.10E−02 | −3.77E−02 | −2.91E−02 | −4.00E−02 |
| B | 2.07E−02 | −3.91E−02 | −2.19E−03 | 7.18E−02 | 1.13E−01 | 2.07E−01 | −6.12E−02 | −2.09E−02 |
| C | −4.58E−02 | 9.31E−02 | 4.23E−02 | −2.07E−01 | −4.56E−01 | −8.85E−01 | 3.15E−01 | 1.44E−01 |
| D | 5.87E−02 | −1.39E−01 | −6.66E−02 | 4.86E−01 | 1.16E+00 | 2.26E+00 | −7.97E−01 | −3.32E−01 |
| E | −4.91E−02 | 1.21E−01 | 3.96E−02 | −7.25E−01 | 1.75E+00 | −3.51E+00 | 1.16E+00 | 4.17E−01 |
| F | 2.60E−02 | −6.51E−02 | −8.66E−04 | 6.62E−01 | 1.61E+00 | 3.40E+00 | −1.03E+00 | −3.11E−01 |
| G | −8.59E−03 | 2.12E−02 | −1.00E−02 | −3.52E−01 | −8.84E−01 | −2.01E+00 | 5.44E−01 | 1.37E−01 |
| H | 1.58E−03 | −3.84E−03 | 4.48E−03 | 9.91E−02 | 2.65E−01 | 6.62E−01 | −1.58E−01 | −3.28E−02 |
| J | −1.23E−04 | 2.98E−04 | −6.27E−04 | −1.14E−02 | −3.34E−02 | −9.37E−02 | 1.91E−02 | 3.27E−03 |
| Surface | 10 | 11 | 12 | 13 | 14 | 15 | 16 | 17 |
| K | −6.20E+01 | −9.00E+01 | −6.90E+01 | −8.82E+01 | −4.33E+01 | −5.70E+00 | −8.06E+01 | −1.24E+01 |
| A | −2.77E−02 | 1.43E−02 | −7.04E−02 | −1.24E−01 | −2.70E−03 | 8.16E−02 | −1.29E−01 | −8.25E−02 |
| B | −2.61E−02 | −1.10E−01 | 4.94E−02 | 8.09E−02 | −3.75E−02 | −9.85E−02 | 4.79E−02 | 3.12E−02 |
| C | 1.57E−02 | 1.44E−01 | −3.05E−02 | −4.99E−02 | 4.13E−03 | 4.20E−02 | −1.09E−02 | −6.93E−03 |
| D | −1.26E−03 | −1.28E−01 | 1.35E−03 | 1.40E−02 | 2.45E−03 | −1.10E−02 | 1.65E−03 | 1.02E−03 |
| E | −1.10E−02 | 7.40E−02 | 7.48E−03 | 5.53E−05 | −9.78E−04 | 1.81E−03 | −1.65E−04 | −1.03E−04 |
| F | 8.67E−03 | −2.77E−02 | −4.19E−03 | −1.09E−03 | 1.75E−04 | −1.83E−04 | 1.07E−05 | 7.01E−06 |
| G | −2.76E−03 | 6.44E−03 | 1.04E−03 | 2.93E−04 | −1.71E−05 | 1.12E−05 | −4.35E−07 | −3.02E−07 |
| H | 3.14E−04 | −8.31E−04 | −1.23E−04 | −3.36E−05 | 8.49E−07 | −3.95E−07 | 1.00E−08 | 7.37E−09 |
| J | 5.56E−06 | 4.49E−05 | 5.73E−06 | 1.48E−06 | −1.60E−08 | 6.48E−09 | −9.96E−11 | −7.76E−11 |

### Tenth Embodiment

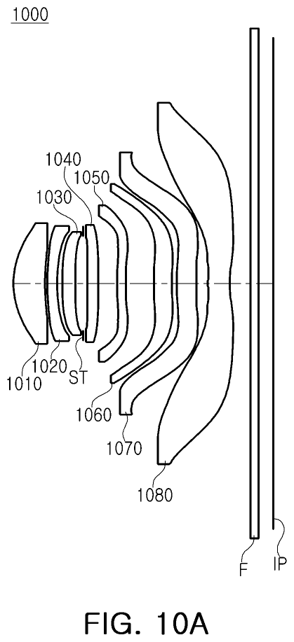

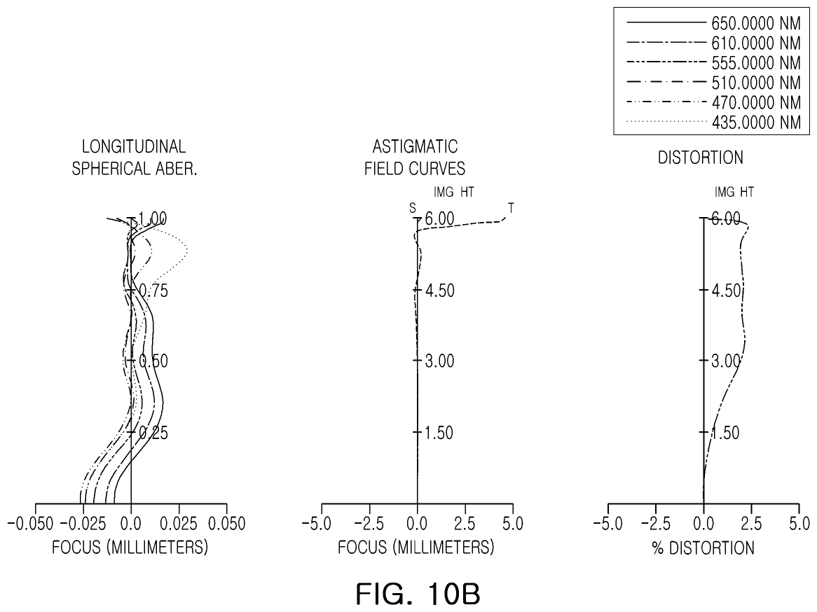

FIG. 10A is a configuration diagram of an optical imaging system according to a tenth embodiment of the present disclosure. FIG. 10B are graphs illustrating the aberration characteristics of the optical imaging system according to the tenth embodiment of the present disclosure.

According to the tenth embodiment, an optical imaging system 1000 may include a first lens 1010, a second lens 1020, a third lens 1030, a fourth lens 1040, a fifth lens 1050, a sixth lens 1060, a seventh lens 1070, and an eighth lens 1080, sequentially arranged from an object side, and may further include an infrared cut-off filter F and an image sensor (an imaging plane (IP)), arranged on an image side of the eighth lens 1080. Additionally, the optical imaging system 1000 may further include a stop ST disposed between the third lens 1030 and the fourth lens 1040.

The first lens 1010 may have a positive refractive power. An object-side surface of the first lens 1010 may be convex in a paraxial region, and an image-side surface of the first lens 1010 may be concave in the paraxial region. The first lens 1010 may be formed of a plastic material. Additionally, the first lens 1010 may be an aspherical lens. For example, the first lens 1010 may be a double-sided aspherical lens in which both the object-side surface and the image-side surface are aspherical.

The second lens 1020 may have a negative refractive power. An object-side surface of the second lens 1020 may be convex in a paraxial region, and an image-side surface of the second lens 1020 may be concave in the paraxial region. The second lens 1020 may be formed of a plastic material. For example, the second lens 1020 may be formed of a plastic material having different optical properties (e.g., a different refractive index and Abbe number) than the first lens 1010, and in an example, an Abbe number of the second lens 1020 may be less than 20. Additionally, the second lens 1020 may be an aspherical lens. For example, the second lens 1020 may be a double-sided aspherical lens in which both the object-side surface and the image-side surface are aspherical.

The third lens 1030 may have a positive refractive power. An object-side surface of the third lens 1030 may be convex in a paraxial region, and an image-side surface of the third lens 1030 may be concave in the paraxial region. The third lens 1030 may be formed of a plastic material. For example, the third lens 1030 may be formed of a plastic material having different optical properties (e.g., a different refractive index and Abbe number) than the second lens 1020. Additionally, the third lens 1030 may be an aspherical lens. For example, the third lens 1030 may be a double-sided aspherical lens in which both the object-side surface and the image-side surface are aspherical.

The fourth lens 1040 may have a positive refractive power. An object-side surface of the fourth lens 1040 may be convex in a paraxial region, and an image-side surface of the fourth lens 1040 may be concave in the paraxial region. The fourth lens 1040 may be formed of a plastic material. For example, the fourth lens 1040 may be formed of a plastic material having different optical properties (e.g., a different refractive index and Abbe number) than the third lens 1030. Additionally, the fourth lens 1040 may be an aspherical lens. For example, the fourth lens 1040 may be a double-sided aspherical lens in which both the object-side surface and the image-side surface are aspherical.

The fifth lens 1050 may have a negative refractive power. An object-side surface of the fifth lens 1050 may be convex in a paraxial region, and an image-side surface of the fifth lens 1050 may be concave in the paraxial region. The fifth lens 1050 may be formed of a plastic material. For example, the fifth lens 1050 may be formed of a plastic material having different optical properties (e.g., a different refractive index and Abbe number) than the fourth lens 1040, and in an example, an Abbe number of the fifth lens 1050 may be less than 20. Additionally, the fifth lens 1050 may be an aspherical lens. For example, the fifth lens 1050 may be a double-sided aspherical lens in which both the object-side surface and the image-side surface are aspherical.

The sixth lens 1060 may have a negative refractive power. An object-side surface of the sixth lens 1060 may be convex in a paraxial region, and an image-side surface of the sixth lens 1060 may be concave in the paraxial region. The sixth lens 1060 may be formed of a plastic material. For example, the sixth lens 1060 may be formed of a plastic material having different optical properties (e.g., a different refractive index and Abbe number) than the fifth lens 1050. Additionally, the sixth lens 1060 may be an aspherical lens. For example, the sixth lens 1060 may be a double-sided aspherical lens in which both the object-side surface and the image-side surface are aspherical.

The seventh lens 1070 may have a positive refractive power. An object-side surface of the seventh lens 1070 may be convex in a paraxial region, and an image-side surface of the seventh lens 1070 may be concave in the paraxial region. The seventh lens 1070 may be formed of a plastic material. For example, the seventh lens 1070 may be formed of a plastic material having different optical properties (e.g., a different refractive index and Abbe number) than the sixth lens 1060. Additionally, the seventh lens 1070 may be an aspherical lens. For example, the seventh lens 1070 may be a double-sided aspherical lens in which both the object-side surface and the image-side surface are aspherical.

The eighth lens 1080 may have a negative refractive power. An object-side surface of the eighth lens 1080 may be convex in a paraxial region, and an image-side surface of the eighth lens 1080 may be concave in the paraxial region. The eighth lens 1080 may be formed of a plastic material. For example, the eighth lens 1080 may be formed of a plastic material having different optical properties (e.g., a different refractive index and Abbe number) than the seventh lens 1070. Additionally, the eighth lens 1080 may be an aspherical lens. For example, the eighth lens 1080 may be a double-sided aspherical lens in which both the object-side surface and the image-side surface are aspherical.

Table 19 below illustrates optical and physical parameters of the optical imaging system 1000 according to the tenth embodiment of the present disclosure.

TABLE 19

| | Radius of | Thickness/ | Refractive | Abbe | Effective |
|---|---|---|---|---|---|
| Surface | Curvature | Distance | Index | number | Diameter |
| Object | Infinity | Infinity | | | |
| 1 | 2.045 | 0.769 | 1.546 | 55.990 | 1.488 |
| 2 | 9.752 | 0.050 | | | 1.449 |
| 3 | 8.189 | 0.220 | 1.677 | 19.238 | 1.393 |
| 4 | 3.462 | 0.135 | | | 1.273 |
| 5 | 5.188 | 0.303 | 1.570 | 37.403 | 1.258 |
| 6 | 8.175 | 0.194 | | | 1.175 |
| STOP | Infinity | 0.111 | | | 1.161 |
| 7 | 26.181 | 0.265 | 1.546 | 55.990 | 1.276 |
| 8 | 116.645 | 0.438 | | | 1.434 |
| 9 | 4.367 | 0.220 | 1.677 | 19.238 | 1.646 |
| 10 | 4.093 | 0.683 | | | 1.909 |
| 11 | 6.898 | 0.431 | 1.570 | 37.403 | 2.228 |
| 12 | 5.063 | 0.115 | | | 2.414 |
| 13 | 4.364 | 0.480 | 1.546 | 55.990 | 2.672 |
| 14 | 25.743 | 0.282 | | | 2.960 |
| 15 | 18.379 | 0.520 | 1.537 | 55.735 | 4.166 |
| 16 | 2.367 | 0.500 | | | 4.367 |
| 17 | Infinity | 0.210 | 1.518 | 64.197 | |
| 18 | Infinity | 0.324 | | | |
| Image | Infinity | | | | |

Table 20 below illustrates aspheric data of the optical imaging system 1000 according to the tenth embodiment of the present disclosure.

TABLE 20

| Surface | 1 | 2 | 3 | 4 | 5 | 6 | 8 | 9 |
|---|---|---|---|---|---|---|---|---|
| K | −1.24E+00 | −9.00E+01 | 2.53E+01 | 3.07E+00 | 1.40E+01 | 4.19E+01 | 9.00E+01 | 9.00E+01 |
| A | 8.04E−03 | 1.86E−02 | −6.98E−04 | −2.21E−02 | −3.20E−02 | −3.36E−02 | −4.31E−02 | 4.01E−02 |
| B | 2.94E−02 | −8.66E−02 | −8.05E−02 | −1.43E−02 | 1.05E−02 | 1.69E−01 | 2.73E−02 | −2.53E−02 |
| C | −7.57E−02 | 2.14E−01 | 2.95E−01 | 1.09E−01 | −6.35E−02 | −7.83E−01 | −1.42E−02 | 1.63E−01 |
| D | 1.10E−01 | −3.22E−01 | −5.06E−01 | −1.35E−01 | 3.15E−01 | 2.20E+00 | −8.87E−02 | −3.79E−01 |
| E | −1.03E−01 | 2.93E−01 | 5.07E−01 | 1.17E−02 | −6.29E−01 | −3.74E+00 | 2.41E−01 | 4.87E−01 |
| F | 6.01E−02 | −1.67E−01 | −3.10E−01 | 1.26E−01 | 6.94E−01 | 3.93E+00 | −2.90E−01 | −3.75E−01 |
| G | −2.17E−02 | 5.82E−02 | 1.14E−01 | −1.18E−01 | −4.29E−01 | −2.50E+00 | 1.90E−01 | 1.72E−01 |
| H | 4.37E−03 | −1.13E−02 | −2.32E−02 | 4.32E−02 | 1.39E−01 | 8.81E−01 | −6.49E−02 | −4.31E−02 |
| J | −3.73E−04 | 9.48E−04 | 1.98E−03 | −5.71E−03 | −1.88E−02 | −1.33E−01 | 8.95E−03 | 4.52E−03 |

| Surface | 10 | 11 | 12 | 13 | 14 | 15 | 16 | 17 |
|---|---|---|---|---|---|---|---|---|
| K | −1 6.05E+0 | −8.16E+0 | −9.00E+0 | −8.36E+01 | −3.82E+01 | 3.06E+01 | −4.68E+01 | −1.28E+01 |
| A | −3.59E−02 | 2.13E−03 | −7.16E−02 | −1.12E−01 | −1.02E−03 | 8.08E−02 | −1.32E−01 | −7.63E−02 |
| B | −3.37E−03 | −8.08E−02 | 5.81E−02 | 5.58E−02 | −4.36E−02 | −9.52E−02 | 4.86E−02 | 2.63E−02 |
| C | −9.80E−03 | 1.02E−01 | −4.53E−02 | −2.90E−02 | 6.34E−03 | 3.87E−02 | −1.06E−02 | −5.30E−03 |
| D | 6.48E−03 | −9.01E−02 | 1.62E−02 | 4.85E−03 | 2.25E−03 | −9.47E−03 | 1.53E−03 | 7.10E−04 |
| E | 2.05E−03 | 5.14E−02 | −1.71E−03 | 1.94E−03 | −1.03E−03 | 1.40E−03 | −1.46E−04 | −6.71E−05 |
| F | −8.32E−03 | −1.90E−02 | −8.17E−04 | −1.12E−03 | 1.93E−04 | −1.20E−04 | 9.09E−06 | 4.38E−06 |
| G | 6.14E−03 | 4.36E−03 | 3.16E−04 | 2.35E−04 | −1.90E−05 | 5.59E−06 | −3.55E−07 | −1.84E−07 |
| H | −1.98E−03 | −5.55E−04 | −4.07E−05 | −2.38E−05 | 9.09E−07 | −1.20E−07 | 7.88E−09 | 4.44E−09 |
| J | 2.43E−04 | 2.95E−05 | 1.78E−06 | 9.70E−07 | −1.48E−08 | 7.38E−10 | −7.62E−11 | −4.64E−11 |

Table 21 below illustrates optical and physical parameters related to the focal length and conditional expression of the optical imaging system according to embodiments of the present disclosure.

TABLE 21

| | Ex1 | Ex2 | Ex3 | Ex4 | Ex5 | Ex6 | Ex7 | Ex8 | Ex9 | Ex10 |
|---|---|---|---|---|---|---|---|---|---|---|
| f | 6.419 | 6.419 | 6.419 | 6.308 | 6.198 | 6.091 | 5.986 | 5.882 | 5.770 | 5.655 |
| f1 | 5.539 | 5.369 | 5.211 | 5.156 | 5.018 | 4.933 | 4.859 | 4.773 | 4.600 | 4.579 |
| f2 | −13.205 | −12.155 | −11.350 | −11.107 | −10.430 | −10.087 | −9.940 | −9.654 | −8.992 | −9.029 |
| f3 | 45.000 | 36.242 | 34.267 | 33.199 | 32.594 | 31.521 | 30.357 | 28.381 | 24.448 | 24.023 |
| f4 | 31.851 | 45.543 | 51.865 | 56.556 | 70.918 | 75.062 | 86.408 | 54.999 | 64.476 | 61.789 |
| f5 | −26.158 | −31.045 | −33.356 | −34.627 | −51.544 | −73.532 | −105.388 | −107.797 | −189.22 | −142.638 |
| f6 | −132.065 | −66.524 | −5053.740 | 1341.600 | −30722.000 | −72.165 | −22.555 | −19.431 | 2468.040 | −36.504 |
| f7 | 8.937 | 9.539 | 11.437 | 10.788 | 11.421 | 9.586 | 7.454 | 7.133 | 12.769 | 9.551 |
| f8 | −5.015 | −5.404 | −5.255 | −5.136 | −5.315 | −5.090 | −5.065 | −4.930 | −4.927 | −5.121 |
| TTL | 7.320 | 7.200 | 7.080 | 6.960 | 6.841 | 6.720 | 6.660 | 6.481 | 6.359 | 6.250 |
| BFL | 1.079 | 1.052 | 1.044 | 1.034 | 1.036 | 1.034 | 1.037 | 1.057 | 1.052 | 1.034 |
| Fno | 1.620 | 1.650 | 1.680 | 1.710 | 1.740 | 1.770 | 1.800 | 1.830 | 1.870 | 1.900 |
| IMGHT | 6.000 | 6.000 | 6.000 | 6.000 | 6.000 | 6.000 | 6.000 | 6.000 | 6.000 | 6.000 |
| FOV | 85.00 | 85.00 | 85.00 | 86.00 | 87.00 | 88.00 | 89.00 | 90.00 | 91.00 | 92.00 |

According to embodiments of the present disclosure described above, the optical imaging system may be manufactured to be slim relative to the size of an image sensor.

According to embodiments of the present disclosure, a slimmed optical imaging system having a short total track length relative to the size of an image sensor may be provided.

An aspect of the present disclosure is to provide an optical imaging system having a short total track length relative to a size of an image sensor.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens, a second lens, a third lens, a fourth lens having a positive refractive power, a fifth lens, a sixth lens, a seventh lens, and an eighth lens having a convex object-side surface, sequentially arranged from an object side to an imaging plane side,
wherein the optical imaging system satisfies:
$$TTL / {( {2}^{*} IMG HT )}^{*} Fno < 1. ,$$
where TTL is a distance from an object-side surface of the first lens to an imaging plane, IMG HT is half a diagonal length of the imaging plane, and Fno is an F value of the optical imaging system.

2. The optical imaging system of claim 1, further comprising a stop disposed between the third lens and the fourth lens.

3. The optical imaging system of claim 1, wherein the second lens and the fifth lens have an Abbe number of less than 20.

4. The optical imaging system of claim 1, wherein the fourth lens has a convex object-side surface.

5. The optical imaging system of claim 1, wherein the fourth lens has a convex image-side surface.

6. The optical imaging system of claim 1, wherein the sixth lens has a negative refractive power.

7. The optical imaging system of claim 1, wherein the optical imaging system satisfies:
$$1.1 \leq TTL / f \leq 1.2 ,$$
where f is a focal length of the optical imaging system.

8. The optical imaging system of claim 1, wherein the third lens has a positive refractive power, and the fifth lens has a negative refractive power.

9. An optical imaging system comprising:
a first lens having a positive refractive power;
a second lens having a negative refractive power;
a third lens having a positive refractive power;
a fourth lens having a refractive power;
a fifth lens having a negative refractive power;
a sixth lens having a refractive power;
a seventh lens having a positive refractive power; and
an eighth lens having a negative refractive power,
wherein the first to eighth lenses are sequentially arranged from an object side to an imaging plane side, and
wherein the optical imaging system satisfies:
$$TTL / {( {2}^{*} IMG HT )}^{*} Fno < 1. ,$$
where TTL is a distance from an object-side surface of the first lens to an imaging plane, IMG HT is half a diagonal length of the imaging plane, and Fno is an F value of the optical imaging system.

10. The optical imaging system of claim 9, further comprising a stop disposed between the third lens and the fourth lens,
wherein the optical imaging system satisfies:
$$v 2 + v 5 < 40 ,$$
where v2 has an Abbe number of the second lens, and v5 has an Abbe number of the fifth lens.

11. The optical imaging system of claim 9, wherein the fourth lens has a positive refractive power and a convex image-side surface.

12. The optical imaging system of claim 9, wherein the eighth lens has a convex object-side surface.

13. The optical imaging system of claim 9, wherein the fourth lens has a convex object-side surface.

14. The optical imaging system of claim 9, wherein the sixth lens has a positive refractive power.

15. The optical imaging system of claim 9, wherein the sixth lens has a convex object-side surface and a concave image-side surface.

16. The optical imaging system of claim 9, wherein the optical imaging system satisfies:
$$0.5 \leq TTL / ( {2}^{*} IMG HT ) < 0.62 .$$
